(19) United States
(12) Patent Application Publication
(10) Pub. No.: US 2024/0397399 A1
(43) Pub. Date: Nov. 28, 2024

(54) METHODS OF TRANSITION OF BEARERS

(71) Applicant: QUALCOMM Incorporated, San Diego, CA (US)

(72) Inventors: Hemant GUPTA, Hyderabad (IN); Sandip HOMCHAUDHURI, San Jose, CA (US); Mayank BATRA, Cambridge (GB); Benjamin James CAMPBELL, Bury St Edmunds (GB)

(21) Appl. No.: 18/686,340

(22) PCT Filed: May 9, 2022
(86) PCT No.: PCT/US2022/028370

§ 371 Date: Feb. 23, 2024

(30) Foreign Application Priority Data
Oct. 21, 2021 (IN) 202141047886

(51) Int. Cl. H04W 36/14; H04W 36/30; H04W 36/32; H04W 84/12; H04W 84/18

(52) U.S. Cl. CPC H04W 36/1446; H04W 36/304; H04W 36/322; H04W 84/12; H04W 84/18

(57) ABSTRACT

A wireless device establishes a Bluetooth connection with a peripheral device based on one or more Bluetooth Specifications, and transmits one or more first Bluetooth-encoded data frames to the peripheral device over the Bluetooth connection. The wireless device initiates a first handover operation for communications with the peripheral device responsive to a link metric of the Bluetooth connection being less than a first link metric threshold. In some instances, the first handover operation includes selecting an access point (AP) of one or more candidate APs based on signal strengths of frames received from the one or more candidate APs, and switching the communications between the wireless device and the peripheral device from the Bluetooth connection to a wireless local area network (WLAN) channel associated with the selected AP. The wireless device transmits one or more second Bluetooth-encoded data frames to the peripheral device over the WLAN channel.

### CROSS-REFERENCE TO RELATED APPLICATIONS

The present Application is a 371 national stage filing of International PCT Application No. PCT/US2022/028370 by GUPTA et al. entitled “METHODS OF TRANSITION OF BEARERS,” filed May 9, 2022; and claims priority to Indian patent application No. 202141047886 entitled “METHODS OF TRANSITION OF BEARERS” and filed on Oct. 21, 2021, each of which is assigned to the assignee hereof, and each of which is expressly incorporated by reference in its entirety herein.

### TECHNICAL FIELD

This disclosure relates generally to wireless communications, and more specifically, to handover operations between Bluetooth communications and Wi-Fi communications.

### DESCRIPTION OF THE RELATED TECHNOLOGY

A wireless personal area network (PAN) is a short-range wireless network typically used to interconnect various personal devices, sensors, appliances, and/or IoT devices. For example, PANs based on communication protocols such as Bluetooth® (BT) or Zigbee® may provide wireless connectivity to peripheral devices within a specific distance (such as 5 meters, 10 meter, 20 meters, 100 meters, etc.) of the user.

To reduce power consumption, the Bluetooth Low Energy (BLE) protocol was developed for various applications. Specifically, BLE exploits the infrequent transfer of data by using a low duty cycle operation, and by placing one or both the central device and the peripheral device(s) into a sleep mode between data transmissions, thereby conserving power. Example applications that use BLE include battery-operated sensors and actuators in various medical, industrial, consumer, and fitness applications. BLE may also be used to connect devices such as BLE enabled smart phones, tablets, and laptops. While traditional Bluetooth and BLE offer certain advantages, there exists a need for further improvements in Bluetooth and BLE technology. For example, traditional Bluetooth and BLE have limited range, have limited data capacity throughput, and are susceptible to interference from other devices communicating in the same frequency band (such as Wi-Fi communications).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description presented later.

One innovative aspect of the subject matter described in this disclosure can be implemented as a method for wireless communication by a wireless device. In some implementations, the method includes establishing a Bluetooth connection with a peripheral device based on one or more Bluetooth Specifications, and transmitting one or more first Bluetooth-encoded data frames to the peripheral device over the Bluetooth connection. The method includes initiating a first handover operation for communications between the wireless device and the peripheral device responsive to a link metric of the Bluetooth connection being less than a first link metric threshold, and transmitting one or more second Bluetooth-encoded data frames to the peripheral device over the WLAN channel. In some instances, the first handover operation may include selecting an access point (AP) of one or more candidate APs based on signal strengths of frames received from the one or more candidate APs, and switching the communications between the wireless device and the peripheral device from the Bluetooth connection to a wireless local area network (WLAN) channel associated with the selected AP. In some implementations, the one or more second Bluetooth-encoded data frames are encapsulated within physical layer convergence protocol (PLCP) protocol data units (PPDUs) compliant with the IEEE 802.11 family of wireless communication standards for transmission to the peripheral device over the WLAN channel.

In various implementations, the method may include transmitting one or more additional Bluetooth-encoded data frames to the peripheral device over the Bluetooth connection, without initiating the first handover operation, responsive to the link metric of the Bluetooth connection being greater than the first link metric threshold. In some instances, the link metric includes one or more of received signal strength indicator (RSSI) values of the first Bluetooth-encoded data frames, a quality of the Bluetooth connection, a data rate associated with the Bluetooth connection, a packet error rate (PER) associated with the Bluetooth connection, an average channel access time associated with the Bluetooth connection, or a presence of concurrent downlink (DL) and uplink (UL) transmissions associated with the peripheral device.

In some implementations, selecting the AP may include obtaining RSSI values of beacon frames received from one or more candidate APs, identifying the AP of the one or more candidate APs associated with the beacon frame having a highest RSSI value of the obtained RSSI values; and associating with the identified AP over the WLAN channel.

In other implementations, initiating the first handover operation may also be based on a distance between the peripheral device and the wireless device. In some instances, the first handover operation may be initiated based on the distance being greater than a value or the distance increasing by more than an amount. In other instances, the wireless device may refrain from initiating the first handover operation based on the distance being less than the value or the distance not increasing by more than the amount.

In some other implementations, the link metric may be a level of co-existence interference between the Bluetooth connection and respective WLAN channels associated with the one or more candidate APs. In some instances, the first handover operation may be initiated based on the level of co-existence interference being greater than an interference threshold. In other instances, the wireless device may refrain from initiating the first handover operation based on the level of co-existence interference being less than the interference threshold.

In various aspects, the method also includes initiating a second handover operation for the communications between the wireless device and the peripheral device responsive to a signal strength of a Bluetooth advertisement message received from the peripheral device exceeding a signal strength threshold, switching the communications from the WLAN channel to the Bluetooth connection based on the link metric of the Bluetooth connection being greater than a second link metric threshold, and transmitting one or more third Bluetooth-encoded data frames to the peripheral device over the Bluetooth connection. In some instances, the signal strength may be an average RSSI value of one or more Bluetooth advertisement messages received from the peripheral device, and the second link metric threshold may be based at least in part on a weighted set of RSSI values associated with previously received Bluetooth messages.

Another innovative aspect of the subject matter described in this disclosure can be implemented in a wireless device. In some implementations, the wireless device may include one or more processors and a memory coupled to the one or more processors. The memory stores processor-readable code that, when executed by the one or more processors, is configured to establish a Bluetooth connection with a peripheral device based on one or more Bluetooth Specifications, and to transmit one or more first Bluetooth-encoded data frames to the peripheral device over the Bluetooth connection. Execution of the processor-readable code is configured to initiate a first handover operation for communications between the wireless device and the peripheral device responsive to a link metric of the Bluetooth connection being less than a first link metric threshold, and to transmit one or more second Bluetooth-encoded data frames to the peripheral device over the WLAN channel. In some instances, the first handover operation may include selecting an AP of one or more candidate APs based on signal strengths of frames received from the one or more candidate APs, and switching the communications between the wireless device and the peripheral device from the Bluetooth connection to a WLAN channel associated with the selected AP. In some implementations, the one or more second Bluetooth-encoded data frames are encapsulated within PPDUs compliant with the IEEE 802.11 family of wireless communication standards for transmission to the peripheral device over the WLAN channel.

In various implementations, execution of the processor-readable code is configured to transmit one or more additional Bluetooth-encoded data frames to the peripheral device over the Bluetooth connection, without initiating the first handover operation, responsive to the link metric of the Bluetooth connection being greater than the first link metric threshold. In some instances, the link metric includes one or more of RSSI values of the first Bluetooth-encoded data frames, a quality of the Bluetooth connection, a data rate associated with the Bluetooth connection, a PER associated with the Bluetooth connection, an average channel access time associated with the Bluetooth connection, or a presence of concurrent DL and UL transmissions associated with the peripheral device.

In some implementations, execution of the processor-readable code for selecting the AP may be configured to obtain RSSI values of beacon frames received from one or more candidate APs, to identify the AP of the one or more candidate APs associated with the beacon frame having a highest RSSI value of the obtained RSSI values, and to associate with the identified AP over the WLAN channel.

In other implementations, initiating the first handover operation may also be based on a distance between the peripheral device and the wireless device. In some instances, the first handover operation may be initiated based on the distance being greater than a value or the distance increasing by more than an amount. In other instances, the wireless device may refrain from initiating the first handover operation based on the distance being less than the value or the distance not increasing by more than the amount.

In some other implementations, the link metric may be a level of co-existence interference between the Bluetooth connection and respective WLAN channels associated with the one or more candidate APs. In some instances, the first handover operation may be initiated based on the level of co-existence interference being greater than an interference threshold. In other instances, the wireless device may refrain from initiating the first handover operation based on the level of co-existence interference being less than the interference threshold.

In various aspects, execution of the processor-readable code may be configured to initiate a second handover operation for the communications between the wireless device and the peripheral device responsive to a signal strength of a Bluetooth advertisement message received from the peripheral device exceeding a signal strength threshold, to switch the communications from the WLAN channel to the Bluetooth connection based on the link metric of the Bluetooth connection being greater than a second link metric threshold, and to transmit one or more third Bluetooth-encoded data frames to the peripheral device over the Bluetooth connection. In some instances, the signal strength may be an average RSSI value of one or more Bluetooth advertisement messages received from the peripheral device, and the second link metric threshold may be based at least in part on a weighted set of RSSI values associated with previously received Bluetooth messages.

Another innovative aspect of the subject matter described in this disclosure can be implemented as a method for wireless communication by a wireless device. In some implementations, the method may be performed by a Bluetooth-enabled peripheral device paired with a software-enabled access point (softAP) via a Bluetooth connection. In some instances, the method includes associating with a first access point (AP) operating on a WLAN channel, and exchanging one or more first Bluetooth-encoded data frames with the first AP over the WLAN channel. The method includes switching communications from the first AP to a second AP during a handover operation responsive to a link metric of the WLAN channel indicating one or both of a decrease in RSSI values of the first Bluetooth-encoded data frames or an increase in a packet error rate (PER) of the first Bluetooth-encoded data frames. The method includes exchanging one or more second Bluetooth-encoded data frames with the second AP over the WLAN channel after the handover operation. In some implementations, the first and second Bluetooth-encoded data frames are encapsulated within PPDUs compliant with the IEEE 802.11 family of wireless communication standards for transmission over the WLAN channel.

In some instances, the first AP and the second AP belong to the same basic service set (BSS) or extended BSS (ESS). In various aspects, the peripheral device includes a first earbud and a second earbud, and the first and second earbuds may be paired with the softAP via at least one of an Asynchronous Connection-Less (ACL) link, a Logical Link Control and Adaptation Protocol (L2CAP) link, an Advanced Audio Distribution Profile (A2DP) link, a Synchronous Connection-Oriented (SCO) link, or an Isochronous (ISO) link.

In various implementations, the method also includes exchanging one or more additional Bluetooth-encoded data frames with the first AP over the WLAN channel responsive to the link metric of the WLAN channel indicating one or both of an absence of the decrease in the RSSI values of the first Bluetooth-encoded data frames or an absence of the increase in the PER of the first Bluetooth-encoded data frames.

In some instances, switching the communications during the handover operation is further based on respective distances between the peripheral device and each of the first AP and the second AP. In other instances, switching the communications during the handover operation is further based, at least in part, on a location of the peripheral device being outside a wireless coverage area of the first AP, on the location of the peripheral device being outside a wireless coverage area of the softAP, on the location of the peripheral device being within a wireless coverage area of the second AP, or any combination thereof.

Another innovative aspect of the subject matter described in this disclosure can be implemented in a Bluetooth-enabled peripheral device. In some implementations, the Bluetooth-enabled peripheral device may include one or more processors and a memory coupled to the one or more processors. The memory stores processor-readable code that, when executed by the one or more processors, is configured to associate with a first AP operating on a WLAN channel, and to exchange one or more first Bluetooth-encoded data frames with the first AP over the WLAN channel. Execution of the processor-readable code is configured to switch communications from the first AP to a second AP during a handover operation responsive to a link metric of the WLAN channel indicating one or both of a decrease in RSSI values of the first Bluetooth-encoded data frames or an increase in a packet error rate (PER) of the first Bluetooth-encoded data frames. Execution of the processor-readable code is configured to exchange one or more second Bluetooth-encoded data frames with the second AP over the WLAN channel after the handover operation. In some implementations, the first and second Bluetooth-encoded data frames are encapsulated within PPDUs compliant with the IEEE 802.11 family of wireless communication standards for transmission over the WLAN channel.

In some instances, the first AP and the second AP belong to the same BSS or ESS. In various aspects, the peripheral device includes a first earbud and a second earbud, and the first and second earbuds may be paired with the softAP via at least one of an ACL link, an L2CAP link, an A2DP link, an SCO link, or an ISO link.

In various implementations, execution of the processor-readable code may be configured to exchange one or more additional Bluetooth-encoded data frames with the first AP over the WLAN channel responsive to the link metric of the WLAN channel indicating one or both of an absence of the decrease in the RSSI values of the first Bluetooth-encoded data frames or an absence of the increase in the PER of the first Bluetooth-encoded data frames.

In some instances, switching the communications during the handover operation is further based on respective distances between the peripheral device and each of the first AP and the second AP. In other instances, switching the communications during the handover operation is further based, at least in part, on a location of the peripheral device being outside a wireless coverage area of the first AP, on the location of the peripheral device being outside a wireless coverage area of the softAP, on the location of the peripheral device being within a wireless coverage area of the second AP, or any combination thereof.

Details of one or more implementations of the subject matter described in this disclosure are set forth in the accompanying drawings and the description herein. Other features, aspects, and advantages will become apparent from the description, the drawings, and the claims.

### BRIEF DESCRIPTION OF THE DRAWINGS

FIG. 1 shows a pictorial diagram of an example Wireless Personal Area Network (PAN), according to various aspects of the present disclosure.

FIG. 2 shows a block diagram of a wireless device, according to various aspects of the present disclosure.

FIG. 3 shows a block diagram of a Bluetooth over Internet Protocol (BToIP) protocol stack, according to various aspects of the present disclosure.

FIGS. 4A-4B show example topologies of a wireless network that supports wireless communications using the BToIP protocol disclosed herein.

FIGS. 5A-5B show example topologies of other wireless networks that support wireless communications using the BToIP protocol disclosed herein.

FIG. 6 depicts communications between a wireless device and a peripheral device over a Bluetooth connection and a WLAN channel, according to various aspects of the present disclosure.

FIG. 7 shows a block diagram of another example wireless device, according to various aspects of the present disclosure.

FIG. 8 shows a sequence diagram depicting an example wireless communication that supports handover operations between a wireless device and a peripheral device, according to various aspects of the present disclosure.

FIG. 9 shows a sequence diagram depicting an example wireless communication that supports handover operations between a peripheral device and a wireless device, according to various aspects of the present disclosure.

FIG. 10 shows a flowchart illustrating an example operation for wireless communication that supports handover operations between a wireless device and a peripheral device, according to various aspects of the present disclosure.

FIG. 11 shows a flowchart illustrating an example operation for wireless communication that supports handover operations between a wireless device and a peripheral device, according to various aspects of the present disclosure.

FIG. 12A shows a flowchart illustrating an example operation for wireless communication that supports initiating an example handover operation disclosed herein, according to various aspects of the present disclosure.

FIG. 12B shows a flowchart illustrating an example operation for wireless communication that initiating another example handover operation disclosed herein, according to various aspects of the present disclosure.

FIG. 13A shows a flowchart illustrating an example operation for wireless communication that supports selecting an AP for an example handover operation disclosed herein, according to various aspects of the present disclosure.

FIG. 13B shows a flowchart illustrating an example operation for wireless communication that supports initiating another example handover operation disclosed herein, according to various aspects of the present disclosure.

FIG. 14 shows a flowchart illustrating an example operation for wireless communication that supports handover operations between a peripheral device and a wireless device, according to various aspects of the present disclosure.

FIG. 15 shows a flowchart illustrating another example operation for wireless communication that supports handover operations between a peripheral device and a wireless device, according to various aspects of the present disclosure.

FIG. 16 shows a conceptual data flow diagram illustrating the data flow between different means/components in an example apparatus.

FIG. 17 shows a diagram illustrating an example of a hardware implementation for an apparatus employing a processing system.

Like reference numbers and designations in the various drawings indicate like elements.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Communications based on traditional Bluetooth and BLE suffer from several limitations that can limit user experiences and negatively affect user experiences. For example, the range of traditional Bluetooth and BLE is limited by a single hop radio frequency (RF) transmission. Additionally, traditional Bluetooth and BLE have limited data capacity, which can have several negative effects on user experience. For example, the limited data capacity of traditional Bluetooth and BLE can result in limited audio quality or a quality level unacceptable to the user. Further, traditional Bluetooth and BLE are enabled for radio frequency communication operating within the globally accepted 2.4 GHz Industrial, Scientific & Medical (ISM) frequency band. However, Bluetooth and BLE devices that operate only within the 2.4 GHz frequency band may be subject to interference from other devices communicating with each other in the 2.4 GHz frequency band (such as Wi-Fi devices).

To address these limitations, Bluetooth and BLE devices may be configured in accordance with various aspects of the subject matter disclosed herein to operate using a Bluetooth (BT) over Internet Protocol (BToIP) that allows Bluetooth and BLE data to be communicated over wireless networks that are based on, or that are at least compatible with, Internet Protocol (IP) packets and Transmission Control Protocol/IP (TCP/IP) packets. For example, Bluetooth and BLE devices configured in accordance with the present disclosure can transmit and receive Bluetooth/BLE data over one or more channels associated with a wireless local area network (WLAN) by encapsulating Bluetooth/BLE data within packets formatted according to the IEEE 802.11 family of wireless communication standards. In this way, Bluetooth and BLE devices can communicate with one another in not only the 2.4 GHz frequency band, but also in the 5 GHz, the 6 GHz frequency band, and other suitable frequency bands.

The ability to transmit Bluetooth-encoded data, particularly latency-sensitive traffic, over a WLAN channel or link may reduce latencies and increase throughput relative to similar transmissions over a Bluetooth connection. However, channel conditions on a WLAN channel often change, which may sometimes cause transmissions of Bluetooth-encoded data on the WLAN channel to have higher latencies and lower throughput than similar transmissions over the Bluetooth connection. The link quality of the Bluetooth connection may also change, which may influence handover operations between the WLAN channel and the Bluetooth connection. As such, there a need for improved link selection and link management for wireless devices that can operate on WLAN channels and Bluetooth connections.

Implementations of the subject matter described in this disclosure may be used by a wireless device to dynamically switch such communications between the WLAN channel and the Bluetooth connection concurrently with the transmission of Bluetooth-encoded data to the peripheral device. In some implementations, the wireless device may establish a Bluetooth connection with the peripheral device, and may transmit one or more Bluetooth-encoded data frames to the peripheral device over the Bluetooth connection. The wireless device may obtain an indication of one or more changes in the link metric of the Bluetooth connection, and may selectively initiate a handover operation based on the changes in the Bluetooth link metric. When the Bluetooth link metric is less than a first link metric threshold, the wireless device may initiate the handover operation and switch the communications with the peripheral device from the Bluetooth connection to a WLAN channel. The wireless device may then transmit additional Bluetooth-encoded data frames to the peripheral device over the WLAN channel. The Bluetooth-encoded data frames may be encapsulated within one or more WLAN-compliant PPDUs when transmitted to the peripheral device over the WLAN channel.

Conversely, when the Bluetooth link metric is greater than the first link metric threshold, the wireless device may maintain the communications with the peripheral device on the Bluetooth connection, and may continue transmitting Bluetooth-encoded data frames to the peripheral device over the Bluetooth connection. In some instances, the Bluetooth link metric may include one or more of RSSI values of the first Bluetooth-encoded data frames, a quality of the Bluetooth connection, a data rate associated with the transmission of the first Bluetooth-encoded data frames over the Bluetooth connection, a PER associated with the transmission of the first Bluetooth-encoded data frames over the Bluetooth connection, an average channel access time associated with the Bluetooth connection, or a presence of concurrent DL and UL transmissions associated with the peripheral device.

In some implementations, the wireless device may initiate a second handover operation responsive to the signal strengths of Bluetooth advertisement message received from the peripheral device exceeding a signal strength threshold. Specifically, during the second handover operation, the wireless device may switch the communications with the peripheral device from the WLAN channel to the Bluetooth connection based on the Bluetooth link metric being greater than a second link metric threshold. Thereafter, the wireless device may transmit one or more third Bluetooth-encoded data frames to the peripheral device over the Bluetooth connection.

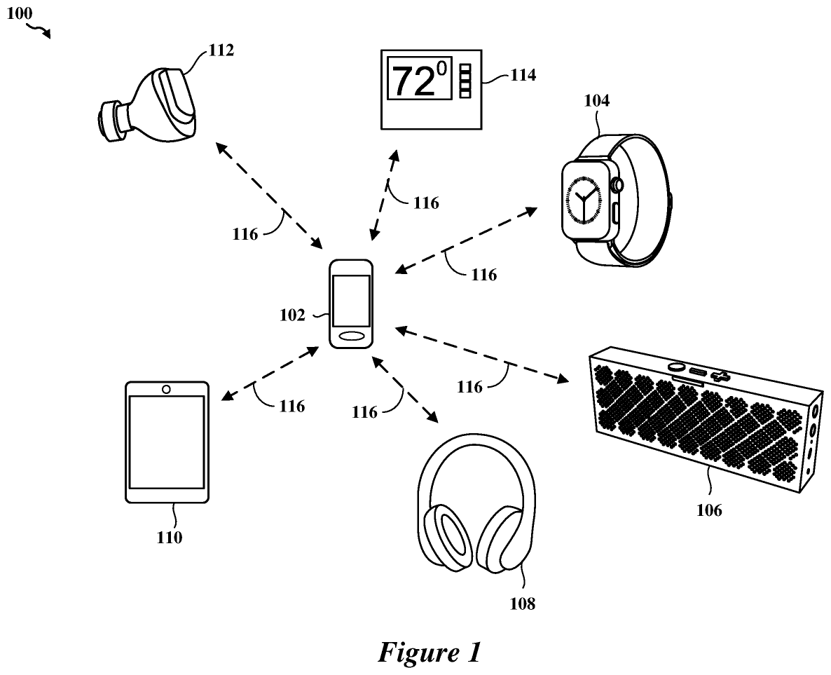

FIG. 1 shows a pictorial diagram of an example Wireless Personal Area Network (PAN) 100, according to some implementations. Within the PAN 100, a central device 102 may connect to and establish a BLE communication link 116 with one or more peripheral devices 104, 106, 108, 110, 112, 114 using a BLE protocol or a modified BLE protocol. The BLE protocol is part of the BT core specification and enables radio frequency communication operating within the globally accepted 2.4 GHz Industrial, Scientific & Medical (ISM) band.

The central device 102 may include suitable logic, circuitry, interfaces, processors, and/or code that may be used to communicate with one or more peripheral devices 104, 106, 108, 110, 112, or 114 using the BLE protocol or the modified BLE protocol as described herein. The central device 102 may operate as an initiator to request establishment of a link layer (LL) connection with an intended peripheral device 104, 106, 108, 110, 112, or 114. A Link Manager may be used to control operations between a BToIP application controller in the central device 102 and a BToIP application controller in each of the intended peripheral devices 104, 106, 108, 110, 112, and/or 114.

After a requested link layer connection is established, the central device 102 may become a host device, and the selected or intended peripheral device 104, 106, 108, 110, 112, or 114 may become paired with the central device 102 over the established link layer connection. As a host device, the central device 102 may be capable of supporting multiple link layer connections at a time with various peripheral devices 104, 106, 108, 110, 112, or 114 operating as client devices. Specifically, the central device 102 may manage various aspects of data packet communication in a link layer connection with one or more of the associated peripheral devices 104, 106, 108, 110, 112, or 114. For example, the central device 102 may determine an operation schedule in the link layer connection with one or more peripheral devices 104, 106, 108, 110, 112, or 114. The central device 102 may also initiate a link layer protocol data unit (PDU) exchange sequence over the link layer connection. Link layer connections may be configured to run periodic connection events in dedicated data channels. The exchange of link layer data PDU transmissions between the central device 102 and one or more of the peripheral devices 104, 106, 108, 110, 112, or 114 may take place within connection events.

In some implementations, the central device 102 may be configured to transmit the first link layer data PDU in each connection event to an intended peripheral device 104, 106, 108, 110, 112, or 114. In other implementations, the central device 102 may utilize a polling scheme to poll the intended peripheral device 104, 106, 108, 110, 112, or 114 for a link layer data PDU transmission during a connection event. The intended peripheral device 104, 106, 108, 110, 112, or 114 may transmit a link layer data PDU upon receipt of packet link layer data PDU from the central device 102. In some other implementations, a peripheral device 104, 106, 108, 110, 112, or 114 may transmit a link layer data PDU to the central device 102 without first receiving a link layer data PDU from the central device 102.

Examples of the central device 102 may include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player, a camera, a game console, a tablet, a smart device, a wearable device (such as a smart watch, wireless headphones, etc.), a vehicle, an electric meter, a gas pump, a toaster, a thermostat, a hearing aid, a blood glucose on-body unit, an Internet-of-Things (IoT) device, or any other similarly functioning device.

Examples of the one or more peripheral devices 104, 106, 108, 110, 112, or 114 may include a cellular phone, a smart phone, a SIP phone, a STA, a laptop, a PC, a desktop computer, a PDA, a satellite radio, a global positioning system, a multimedia device, a video device, a digital audio player, a camera, a game console, a tablet, a smart device, a wearable device (such as a smart watch, wireless headphones, etc.), a vehicle, an electric meter, a gas pump, a toaster, a thermostat, a hearing aid, a blood glucose on-body unit, an IoT device, or any other similarly functioning device. Although the central device 102 is illustrated in communication with six peripheral devices 104, 106, 108, 110, 112, or 114 in the PAN 100, the central device 102 may communicate with more or fewer than six peripheral devices within the PAN 100 without departing from the scope of the present disclosure.

A device implementing the BT protocol, such as the central device 102, may operate according to one radio mode, such as basic rate (BR)/enhanced data rate (EDR), and a device implementing the BLE protocol may operation according to a BLE radio mode. In some aspects, the central device 102 may be configured with dual radio modes, and therefore may be able to operate according to the BR/EDR mode or the BLE mode, for example, based on the type of short-rage wireless communication in which the device may engage.

For example, the central device 102 may operate according to the BR/EDR mode for continuous streaming of data, for broadcast networks, for mesh networks, and/or for some other applications in which a relatively higher data ratemay be more suitable. However, the device may operate according to the BLE mode for short burst data transmissions, such as for some other applications in which power conservation may be desirable and/or a relatively lower data rate may be acceptable. In other aspects, the central device 102 may operate according to one or more other radio modes, including proprietary radio mode(s). Examples of other radio modes may include high speedradio modes, low energy radio modes, isochronous radio modes, etc.

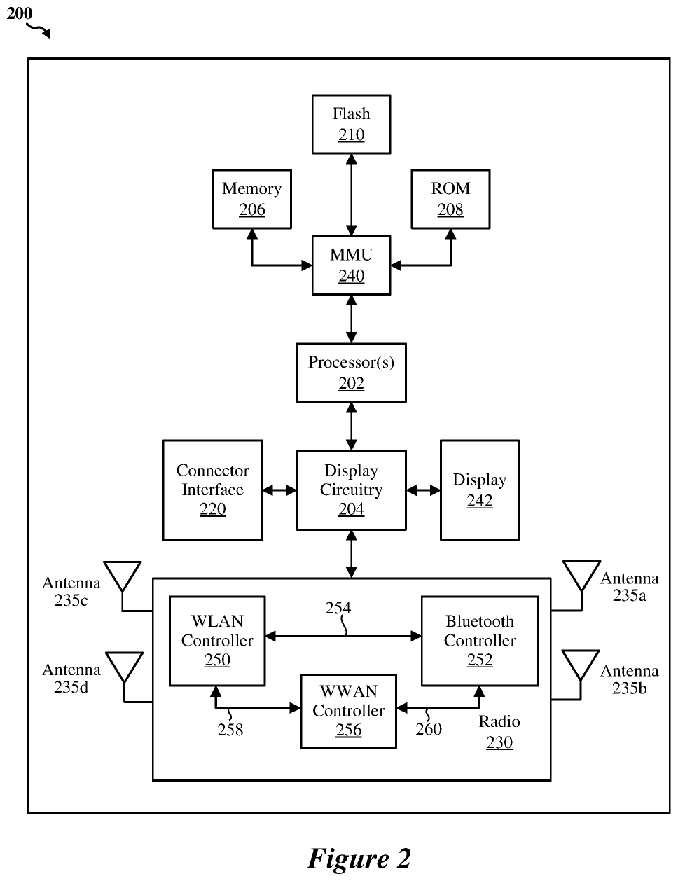

FIG. 2 shows a block diagram of a wireless device 200, according to some implementations. In some instances, the wireless device 200 may be an example of the central device 102 of FIG. 1. In other instances, the wireless device 200 may be an example of one or more of the peripheral devices 104, 106, 108, 110, 112, or 114 of FIG. 1. In some aspects, the wireless device 200 may be a Bluetooth-enabled device (such as a BLE device).

As shown, the wireless device 200 may include a processing element, such as processor(s) 202, which may execute program instructions for the wireless device 200. The wireless device 200 may also include display circuitry 204 that can perform graphics processing and present information to a user via the display 242. The processor(s) 202 may also be coupled to memory management unit (MMU) 240, which may be configured to receive addresses from the processor(s) 202 and translate the addresses to address locations in memory such as memory 206, ROM 208, or Flash memory 210) and/or to address locations in other circuits or devices, such as the display circuitry 204, radio 230, connector interface 220, and/or display 242. The MMU 240 may also be configured to perform memory protection and page table translation or set up. In some aspects, the MMU 240 may be included as a portion of the processor(s) 202.

The processor(s) 202 may be coupled to other circuits of the wireless device 200. For example, the wireless device 200 may include various types of memory, a connector interface 220 through which the wireless device 200 can communicate with the computer system, and wireless communication subsystems that can transmit data to, and receive data from, other devices based on one or more wireless communication standards or protocols. For example, in some aspects, the wireless communication subsystems may include (but are not limited to) a WLAN subsystem, a Bluetooth subsystem, or a cellular subsystem (such as an LTE or 5G NR subsystem). The wireless device 200 may include a plurality of antennas 235a, 235b, 235c, or 235d for performing wireless communication with, for example, wireless devices in a PAN.

The wireless device 200 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as an field programmable gate array (FPGA), and/or an application specific integrated circuit (ASIC).

In certain aspects, the radio 230 may include separate controllers configured to control communications for various respective radio access technology (RAT) protocols. For example, as shown in FIG. 2, radio 230 may include a WLAN controller 250 that manages WLAN communications, a Bluetooth controller 252 that manages Bluetooth and BLE, and a WWAN controller 256 that manages WWAN communications. In certain aspects, the wireless device 200 may store and execute a WLAN software driver for controlling WLAN operations performed by the WLAN controller 250, a Bluetooth software driver for controlling Bluetooth operations performed by the Bluetooth controller 252, and/or a WWAN software driver for controlling WWAN operations performed by the WWAN controller 256.

In certain implementations, a first coexistence interface 254 (such as a wired interface) may be used for sending information between the WLAN controller 250 and the Bluetooth controller 252. In certain other implementations, a second coexistence interface 258 may be used for sending information between the WLAN controller 250 and the WWAN controller 256. In certain other implementations, a third coexistence interface 260 may be used for sending information between the Bluetooth controller 252 and the WWAN controller 256.

In some aspects, one or more of the WLAN controller 250, the Bluetooth controller 252, and/or the WWAN controller 256 may be implemented as hardware, software, firmware or some combination thereof.

In certain configurations, the WLAN controller 250 may be configured to communicate with a second device in a PAN using a WLAN link using all of the antennas 235a, 235b, 235c, and 235d. In certain other configurations, the Bluetooth controller 252 may be configured to communicate with at least one second device in a PAN using one or more of the antennas 235a, 235b, 235c, and 235d. In certain other configurations, the WWAN controller 256 may be configured to communicate with a second device in a PAN using all of the antennas 235a, 235b, 235c, and 235d. The WLAN controller 250, the Bluetooth controller 252, and/or the WWAN controller 256 may be configured to adjust wakeup time interval and shutdown time for the device.

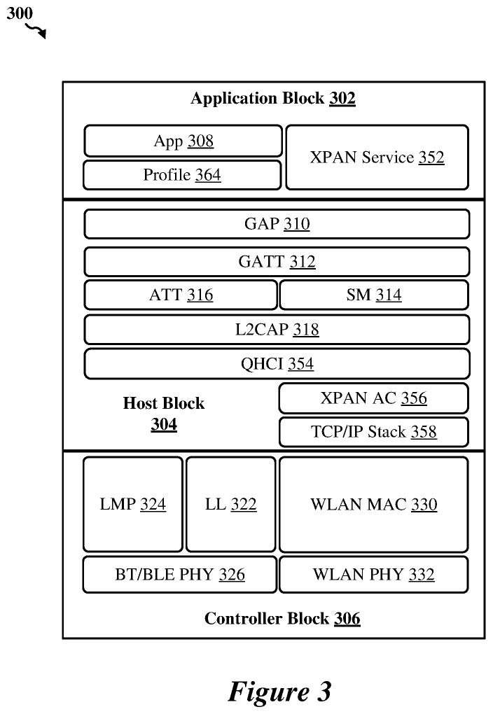

FIG. 3 shows a block diagram of a BToIP protocol stack 300, according to some implementations. The BToIP protocol stack 300 may be implemented by one or more of processor(s) 202, memory 206, Flash memory 210, ROM 208, the radio 230, and/or the Bluetooth controller 252 described with reference to FIG. 2. In some implementations, the BToIP protocol stack 300 may be organized into three blocks, namely, the Application block 302, the Host block 304, and the Controller block 306. The Application block 302 may be a user application that interfaces with the other blocks and/or layers of the BToIP protocol stack 300. In some aspects, the Application block 302 may include one or more applications and one or more Bluetooth profiles that allow the applications to use the Bluetooth (BT) and BLE communications. The Host block 304 may include the upper layers of the BToIP protocol stack 300, and the Controller block 306 may include the lower layers of the BToIP protocol stack 300. The Host block 304 may communicate with a controller (such as the Bluetooth controller 252 of FIG. 2) in a wireless device using a Host Controller Interface (HCl) such as QHCI 354. The QHCI 354 may also be used as an interface between the Controller block 306 and the Host block 304 that allows a wide range of Hosts to interface with the Controller block 306. In some aspects, the Controller block 306 may be used for hardware interface management, link establishment, and link management.

The Application block 302 may include a higher-level Application Layer (App) 308, a Profile Layer (Profile) 364, and a BToIP Service layer 352. The Host block 304 may include a Generic Access Profile (GAP) 310, a Generic Attribute Protocol (GATT) 312, a Security Manager (SM) 314, an Attribute Protocol (ATT) 316, a Logical Link Control and Adaptation Protocol (L2CAP) 318, and the QHCI 354. In some aspects, the Host block 304 may also include a BToIP Application Controller (BToIP AC) 356 and a TCP/IP stack 358. The Controller block 306 may include a Link Layer (LL) 322, a Link Manager Protocol (LMP) 324, a BT/BLE Physical Layer (PHY) 326, a WLAN MAC 330, and a WLAN Physical Layer (WLAN PHY) 332.

To support IoT applications, audio applications, and other applications, the BT/BLE PHY 326 may be configured to support wider communication bandwidths and data rate than PHYs associated with conventional Bluetooth or BLE protocol stacks. For example, in some aspects, the BT/BLE PHY 326 may define the mechanism for transmitting a bit stream over a physical link that connects BLE devices. The bit stream may be grouped into code words or symbols, and converted to a PDU that is transmitted over a wireless medium. The BT/BLE PHY 326 may provide an electrical, mechanical, and procedural interface for the wireless medium. Specifically, the BT/BLE PHY 326 may specify the frequency band, the channel bandwidth, the modulation and coding scheme (MCS), the cyclic-shift diversity (CSD), and other physical aspects of wireless transmissions. The WLAN PHY 332 may define the mechanism for transmitting a bit stream over a physical WLAN link that connects two or more devices (such as WLAN devices). The BT/BLE PHY 326 and the WLAN PHY 330 may provide an electrical, mechanical, and procedural interface to the transmission medium. The shapes and properties of the electrical connectors, the frequency band used for transmission, the modulation scheme, and similar low-level parameters may be specified by the BT/BLE PHY 326 and WLAN PHY 330.

The LMP 324 may be responsible for low level communication over the BT/BLE PHY 326. The LMP 324 may manage the sequence and timing of transmitted and received link layer data PDUs, and using a link layer protocol, communicate with other devices regarding connection parameters and data flow control. In some aspects, the LMP 324 may provide gate keeping functionality to limit exposure and data exchange with other devices. In some implementations, the LMP 324 may maintain a list of allowed devices and ignore all requests for baseband PDU exchange from devices not on the list. The LMP 324 may use the QHCI 354 to communicate with upper layers of the BToIP protocol stack 300. In certain aspects, the LMP 324 may be used to generate a baseband PDU and/or an empty packet (such as an empty PDU) that may be transmitted using a LMP communication link established with another traditional BT device (such as a BR/EDR device) using the LMP 324.

The LL 322 may be responsible for low level communication over the BT/BLE PHY 326. The LL 322 may manage the sequence and timing of transmitted and received LL data PDUs, and using a LL protocol, communicate with other devices regarding connection parameters and data flow control. The LL 322 may provide gate keeping functionality to limit exposure and data exchange with other devices. If filtering is configured, the LL 322 may maintain a list of allowed devices and ignore all requests for data PDU exchange from devices not on the list. The LL 322 may use the QHCI 354 to communicate with upper layers of the BToIP protocol stack 300. In certain aspects, the LL 322 may be used to generate a LL data PDU and/or an empty packet (such as an empty PDU) that may be transmitted using a LL communication link established with another BLE device using the LL 322

The L2CAP 318 may encapsulate multiple protocols from the upper layers into a link layer data PDU and/or a QLL establishment PDU (and vice versa). The L2CAP 318 may also break large link layer data PDUs and/or a QLL establishment PDUs from the upper layers into segments that fit into a maximum payload size (such as 27 bytes) on the transmit side. Similarly, the L2CAP 318 may receive multiple link layer data PDUs and/or QLL establishment PDUs that have been segmented, and the L2CAP 318 may combine the segments into a single link layer data PDU and/or a QLL establishment PDU that may be sent to the upper layers.

The ATT 316 may be a client/server protocol based on attributes associated with a BLE device configured for a particular purpose (such as monitoring heart rate, monitoring temperature, broadcasting advertisements, etc.). The attributes may be discovered, read, and written by other BLE enabled devices. The set of operations which are executed over ATT 316 may include, but are not limited to, error handling, server configuration, find information, read operations, write operations, queued writes, etc. The ATT 316 may form the basis of data exchange between BLE devices.

The SM 314 may be responsible for device pairing and key distribution. A security manager protocol implemented by the SM 314 may define how communications with the SM of a counterpart BLE deice are performed. The SM 314 may provide additional cryptographic functions that may be used by other components of the modified BLE protocol stack 300. The architecture of the SM 314 used in BLE may be designed to minimize recourse requirements for peripheral devices by shifting work to a central device. The SM 314 provides a mechanism to not only encrypt the data but also to provide data authentication.

The GATT 312 describes a service framework using the attribute protocol for discovering services, and for reading and writing characteristic values on a counterpart BLE device. The GATT 312 interfaces with the App 308 through the App's profile. The App 308 profile defines the collection of attributes and any permission associated with the attributes to be used in BLE communications. One of the benefits of BT technology is device interoperability. To assure interoperability, using a standardized wireless protocol to transfer bytes of information may be inadequate, and hence, sharing data representation levels may be needed. In other words, BLE devices may send or receive data in the same format using the same data interpretation based on intended device functionality. The attribute profile used by the GATT 312 may act as a bridge between the modified BLE protocol stack and the application and functionality of the BLE device (at least from a wireless connection point of view), and is defined by the profile.

The GAP 310 may provide an interface for the App 308 to initiate, establish, and manage connection with counterpart BT/BLE devices. The profile layer 364 may include a set of BT/BLE profiles including, but not limited to, A2DP, AVRCP, HFP, and the like. The profiles of the profile layer 364 may operate over the L2CAP 318. The BToIP Service 352 may determine whether a peripheral device (such as one of the peripheral devices 104, 106, 108, 110, 112, or 114 of FIG. 1) supports BToIP protocol and/or is enabled to communicate via BToIP protocol. The BToIP Service 352 may be configured to exchange features (such as control point notifications) with the second device based on some triggers, events, and/or conditions detected or determined by the first device (such as via processor 202 of the first device). The exchanged features (such as the control point notifications) may indicate to the second device one or more actions the second device may perform.

The QHCI 354 may determine whether a Bluetooth packet is to be transmitted using a traditional Bluetooth protocol or using the BToIP protocol disclosed herein. The BToIP protocol bearer may be a software enabled access point (softAP) or an access point (AP). A BToIP protocol bearer may operate over multiple globally accepted ISM bands including, but not limited to, the 2.4 GHz ISM band, the 5 GHz ISM band, the 6 GHz ISM band, and the like. In some implementations, a WLAN radio of the device and/or the App layer 308 of the device may be configured to select one of the globally accepted ISM band over which the BToIP protocol bearer operates.

If the QHCI 354 determines that the Bluetooth packet and/or payload is to be transmitted via the BToIP protocol, then the QHCI 354 may route the Bluetooth packet and/or payload to the BToIP AC 356. In some aspects, the QHCI 354 may indicate to the BToIP AC 356 that the Bluetooth packet and/or payload is to be transmitted using the BToIP protocol.

The BToIP AC 356 may be configured to encapsulate data packets in a manner indicating that the data packets are to be transmitted over a WLAN channel or link using the BToIP protocol. For example, the BToIP AC 356 may add, to each data packet that is to be transmitted using the BToIP protocol, a header indicating that the respective data packet is formatted for transmission based on the BToIP protocol. The BToIP AC 356 may also be configured to decapsulate data packets received using the BToIP protocol, and forward the decapsulated data to other layers of the BToIP protocol stack 300. In some aspects, the BToIP AC 356 may decapsulate received BToIP packets by stripping the BToIP headers from the received BToIP packets and forwarding the decapsulated data to the other layers of the BToIP protocol stack 300.

The TCP/IP stack 358 may encapsulate BToIP packets with TCP/IP or TCP/UDP headers and forward the encapsulated BToIP packets to the WLAN MAC 330. The TCP/IP stack 358 may decapsulate packets received via the BToIP link and forward the decapsulated data to the other layers of the BToIP protocol stack 300. The WLAN PHY 332 may transmit BToIP packets to, and receive BToIP packets from, a peripheral device over a WLAN channel or link. In some aspects, the WLAN MAC 330 may be responsible for low level communication over the WLAN PHY 332.

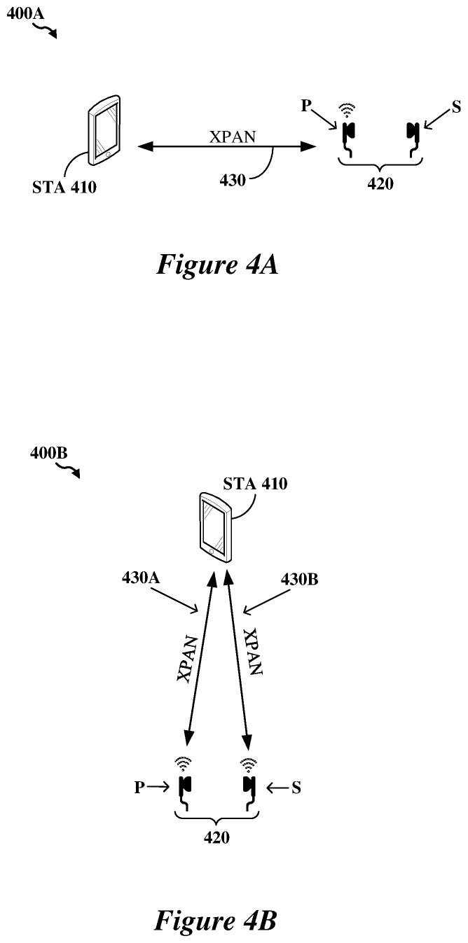

FIGS. 4A-4B show example topologies of wireless networks that support wireless communications using the BToIP disclosed herein. For example, FIG. 4A shows an example wireless network 400A that includes a STA 410 and a pair of earbuds 420 that may be paired with each other via a Bluetooth connection. In some implementations, the STA 410 may be one example of the central device 102 of FIG. 1, and the earbuds 420 may be one example of the peripheral device 112 of FIG. 1. In various aspects, the STA 410 and earbuds 420 are also connected by a communication link 430 over which the STA 410 and the earbuds 420 may exchange data and other information with each other based on the BToIP disclosed herein. As discussed, the BToIP allows the STA 410 to transmit Bluetooth-encoded data (such as an audio stream or a video stream) to the earbuds 420 over the communication link 430 using frames or packets compliant with the IEEE 802.11 family of wireless communication standards.

The communication link 430 may be any suitable contention-based communication link that allows the STA 410 and the earbuds 420 to communicate with each other using WLAN-compliant data packets. In some aspects, the communication link 430 may be a Wi-Fi link such as (but not limited to) a P2P link, a TDLS link, or a Wi-Fi Direct link. In other aspects, the communication link 430 may be one or more wireless channels associated with a BSS, a WLAN, and/or an AP. In some instances, the STA 410 may implement a softAP that operates on the same wireless channels as the STA 410, and the earbuds 420 may be associated with the softAP. In this way, the earbuds 420 may be associated with the softAP, which may allow the STA 410 to communicate directly with the earbuds 420 over the communication link 430 without tunneling through an access point (AP).

FIG. 4B shows an example wireless network 400B that includes the STA 410 and earbuds 420 described with reference to FIG. 4A. The wireless network 400B is similar to the wireless network 400A of FIG. 4A, except that the first and second earbuds (P and S, respectively) in the example of FIG. 4B have direct communication links 430A and 430B, respectively, with the STA 410. In this example, the STA 410 may transmit a data stream to each of the first earbud (P) and the second earbud(S) via respective communication links 430A and 430B, concurrently.

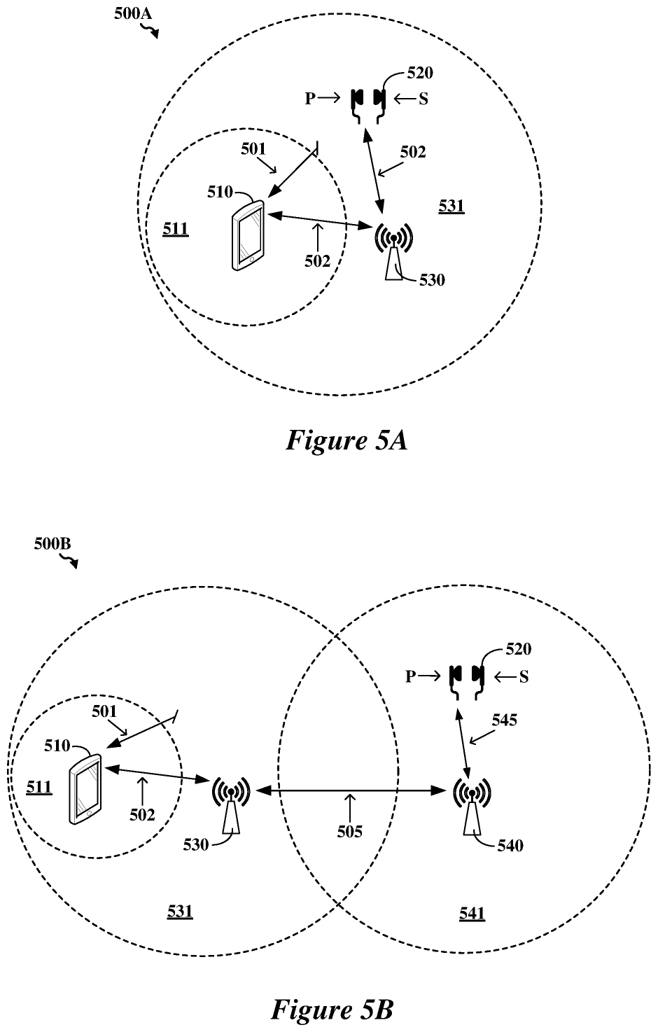

FIG. 5A shows an example topology of another wireless network 500A that supports wireless communications using the BToIP disclosed herein. The wireless network 500A of FIG. 5A is shown to include a STA 510, a pair of earbuds 520 paired with the STA 510 via a Bluetooth connection 501, and an AP 530. In some implementations, the STA 510 may be one example of the central device 102 of FIG. 1, and the earbuds 520 may be one example of the peripheral device 112 of FIG. 1. The AP 530 may operate a BSS on a WLAN channel 502, and may provide a wireless coverage area 531 for WLAN communications over the WLAN channel 502. The STA 510 may be associated with the AP 530, and may receive data streams directly from the AP 530 over the WLAN channel 502. The STA 510 may also provide a wireless coverage area 511 for Bluetooth communications with the earbuds 520 over the Bluetooth connection 501.

In the example of FIG. 5A, the earbuds 520 are located outside of the Bluetooth coverage area 511 provided by the STA 510, and therefore the earbuds 520 may not be able to receive or successfully decode Bluetooth frames transmitted over the Bluetooth connection 501 from the STA 510. As such, when the earbuds 520 are not within the Bluetooth coverage area 511 of the STA 510, or when a link metric of the Bluetooth connection 501 is less than a first link metric threshold, handover operations disclosed herein can be used to switch communications between the STA 510 and the earbuds 520 from the Bluetooth connection 501 to the WLAN channel 502.

In the example of FIG. 5A, the earbuds 520 include a primary earbud (P) and a secondary earbud(S). In some instances, the primary earbud P may be associated with the AP 530, and may serve as the transmit-receive point (TRP) of the earbuds 520. For example, the primary earbud P may relay data received from the AP 530 to the secondary earbud S, and may relay data received from the secondary earbud S to the AP 530. In other instances, each of the primary and secondary earbuds may be independently associated with the AP 530. For example, the AP 530 may transmit a data stream to each of the primary and secondary earbuds, concurrently. In implementations for which the STA 510 includes or operates a softAP, the primary and secondary earbuds may be independently associated with the softAP, or the primary earbud may serve as the TRP of the earbuds 520.

FIG. 5B shows an example wireless network 500B that includes the STA 510, the earbuds 520, and the AP 530 described with reference to FIG. 5A. The example wireless network 500B also includes a second AP 540 that provides a wireless coverage area 541 for one or more other wireless devices (not shown for simplicity). In various aspects, the wireless coverage area 531 provided by AP 530 may overlap with a portion of the wireless coverage area 541 provided by AP 540. In some instances, the APs 530 and 540 may communicate with each other over communication link 505. For example, in some aspects, the communication link 505 may be a wireless channel such as a WLAN channel. In other aspects, the communication link 505 may be a backhaul connection.

In the example of FIG. 5B, the earbuds 520 are not within the Bluetooth coverage area 511 provided by the STA 510, and are not within the wireless coverage area 531 provided by the AP 530. As such, the earbuds 520 may not be able to receive data streams from the STA 510 via the Bluetooth connection 501, and may not be able to receive data streams from the AP 530 over the WLAN channel 502. However, the earbuds 520 are within the wireless coverage area 541 provided by the second AP 540, and may therefore be able to receive data streams transmitted by the second AP 540.

In some implementations, when the earbuds 520 are not within the respective wireless coverage areas 511 and 531 provided by the STA 510 and the AP 530, or when a link metric of the Bluetooth connection 501 is less than the first link metric threshold and a link metric of the WLAN channel 502 is less than a second link metric threshold, handover operations disclosed herein can be used to switch communications with the earbuds 520 from the first AP 530 to the second AP 540. In some instances, one or more of signal strengths, PERs, latencies, throughput, and/or other channel metrics associated with nearby APs (including the APs 530 and 540) may be used to determine or identify nearby APs (including the AP 830) as candidates for the handover operation, and to select one of the candidate APs with which the earbuds 520 can be associated. After performing association and authentication procedures with the earbuds 520, the second AP 540 may transmit Bluetooth-encoded data frames, encapsulated within WLAN-compliant PPDUs, to the earbuds 520 over one or more WLAN channels. In some instances, the earbuds 520 may transmit Bluetooth-encoded data frames encapsulated within WLAN-compliant PPDUs to the second AP 540 over the one or more WLAN channels.

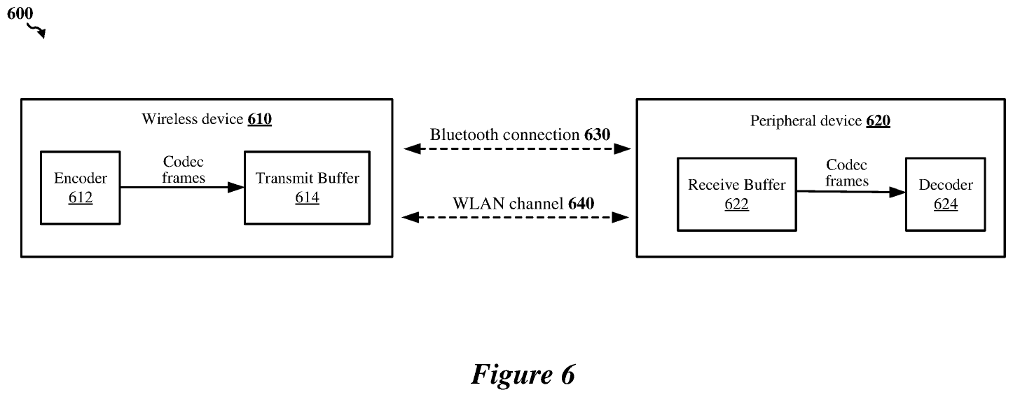

FIG. 6 depicts example communications 600 between a wireless device 610 and a peripheral device 620 over a Bluetooth connection 630 and a WLAN channel 640, according to various aspects of the present disclosure. In some implementations, the wireless device 610 may be one example of the central device 102 of FIG. 1 or the wireless device 200 of FIG. 2, the STA 410 of FIGS. 4A-4B, or the STA 510 of FIGS. 5A-5B. The peripheral device 620 may be an example of one or more of the peripheral devices 104, 106, 108, 110, 112 or 114 of FIG. 1, the earbuds 420 of FIGS. 4A-4B, or the earbuds 520 of FIGS. 5A-5B. The WLAN channel 640 may be one or more wireless channels operated by or associated with a BSS (or an AP that operates the BSS). In various aspects, the wireless channels may be in the 2.4 GHz frequency band, the 5 GHz frequency band, the 6 GHz frequency band, or the 60 GHz frequency band. In some instances, the WLAN channel 640 may be a P2P link, a TDLS link, or a Wi-Fi Direct link.

The wireless device 610 is shown to includer an encoder 612 and a transmit buffer 614. The encoder 612 may be configured to encode data, such as audio or video data, using a specified bitrate. The transmit buffer 614 may be configured to queue data packets that are to be transmitted to the peripheral device 620 over the Bluetooth connection 630 or the WLAN channel 640. In some implementations, the data packets to be transmitted to the peripheral device 620 may be of a predefined size, for example, based whether the transmission is over the Bluetooth connection 630 or the WLAN channel 640 and/or the channel conditions of the link or connection. In some aspects, data encoded by the encoder 612 may be packetized into a data packet of a predefined size. The wireless device 610 may de-queue data packets from the transmit buffer 614 and transmit the data packets to the peripheral device 620 over the Bluetooth connection 630 or the WLAN channel 640.

The peripheral device 620 is shown to includer a receive buffer 622 and a decoder 624. Data packets received over the Bluetooth connection 630 or the WLAN channel 640 may be queued or otherwise stored in the receive buffer 622. The data packets may be output from the receive buffer 622 and forwarded to the decoder 624. In some aspects, the decoder 624 may decode data (such as audio and/or video data) carried in the payloads of the queued data packets, and forward the decoded data to upper layers of the protocol stack for processing and playback to a user.

In some implementations, the encoder 612 may encode a first encoder/decoder (codec) frame using a first bitrate, and forward the first codec frame to the transmit buffer 614 to be packetized for transmission to the peripheral device 620 over the Bluetooth connection 630 or the WLAN channel 640. For instances in which the first codec frame is too large to be packetized within a data packet of the predefined size, a first portion of the first codec frame that fits within a data packet may be de-queued from the transmit buffer 614 and transmitted to the peripheral device 620 over the Bluetooth connection 630 or the WLAN channel 640. A second portion of the first codec frame, which did not fit within the data packet transmitted to the peripheral device 620, may be transmitted to the peripheral device 620 in a subsequent data packet.

The peripheral device 620 may queue the received data packet in the receive buffer 622, and may forward the first portion of the first codec frame to the decoder 624 for decoding. In some instances, the decoder 624 may not be able to decode the first portion of the first codec frame without the second portion of the first codec frame. The resulting delay in decoding the first codec frame may cause “jitter” in the playback of audio and/or video data carried in the first codec frame, which may adversely impact user experience. In some instances, the delay in timely delivery of the first codec frame to the peripheral device 620 may be reduced by increasing the bitrate used to encode the data. In other instances, the delay in timely delivery of the first codec frame to the peripheral device 620 may be reduced by increasing the transmit power level used for transmitting data packets over the Bluetooth connection 630 or the WLAN channel 640 to the peripheral device 620.

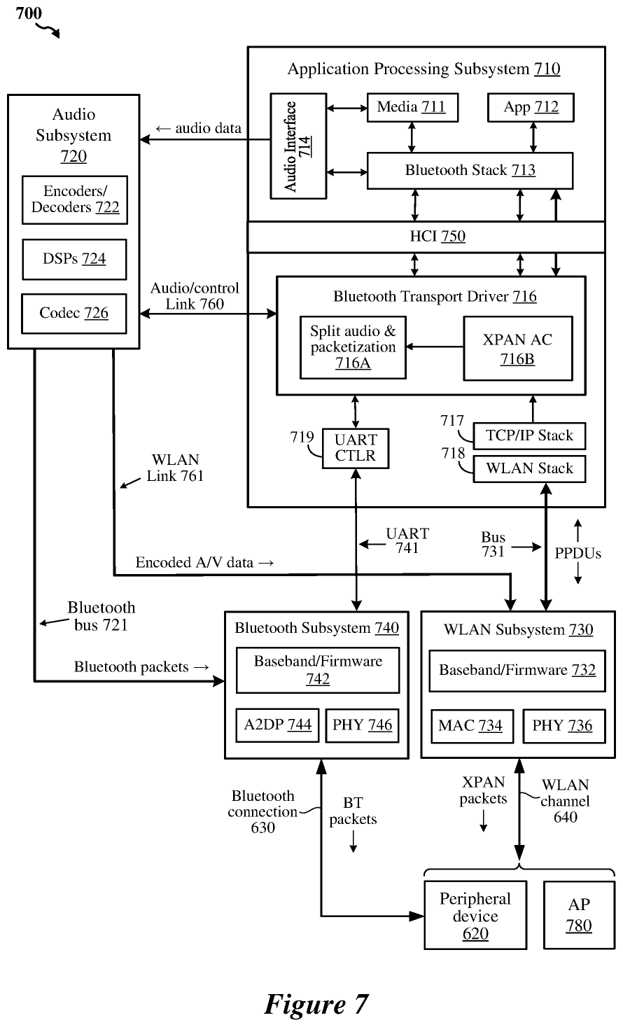

FIG. 7 shows a block diagram of another example wireless device 700, according to various aspects of the present disclosure. In some implementations, the wireless device 700 may be an example of the central device 102 of FIG. 1, the wireless device 200 of FIG. 2, the STA 410 of FIGS. 4A-4B, the STA 510 of FIGS. 5A-5B, or the wireless device 610 of FIG. 6. In some instances, the wireless device 700 may operate as a STA that can transmit data to and receive data from an associated AP 780 over a WLAN channel 781, while also operating as a softAP that can transmit data to and receive data from the peripheral device 620 over a WLAN link 640 using the BToIP protocol disclosed herein. In some instances, the WLAN link 640 may be the same as the WLAN channel 781. In other instances, the WLAN link 640 may be a subset of the WLAN channel 781.

The peripheral device 620 may be paired with the wireless device 700 based on the Bluetooth or BLE protocol. For example, in some aspects, the peripheral device 620 may be a pair of earbuds or headphones that can exchange Bluetooth-encoded data and other signals with the wireless device 700 over a Bluetooth connection 630 using a Bluetooth or BLE protocol, and can also exchange Bluetooth-encoded data and other signals with the wireless device 700 over the WLAN link 640 using the BToIP protocol disclosed herein.

The wireless device 700 may include an Application Processing subsystem 710, an audio subsystem 720, a WLAN subsystem 730, a Bluetooth subsystem 740, and a Host Controller Interface (HCl) 750. The Application Processing subsystem 710, which may correspond to at least some portions of the application layer and the Host block of the BToIP protocol stack 300 of FIG. 3, is shown to include a media player 711, an Application Layer (App) 712, a Bluetooth stack 713, and an audio interface 714. The media player 711 can be suitable device or component capable of generating or receiving multimedia content including, for example, real-time audio streams, real-time video streams, real-time gaming streams, and other latency-sensitive traffic. The App 712, which may be one implementation of the App 308 of FIG. 3, includes at least one Bluetooth profile that defines the collection of attributes and associated permissions to be used in Bluetooth or BLE communications. In some aspects, the App 712 may include processing resources including (but not limited to) the memory 206, the ROM 208, and the Flash memory 210 of FIG. 2. The Bluetooth stack 713 may be one implementation of the BToIP protocol stack 300 of FIG. 3.

The Bluetooth transport driver 716 may include a split audio and packetization module 716A and a BToIP AC 716B. The split audio and packetization module 716A may be responsible for packetizing data (such as audio and/or video data) into Bluetooth frames that can be transmitted to the peripheral device 620 using either a Bluetooth/BLE protocol or the BToIP protocol disclosed herein. The BToIP AC 716B, which may be one example of the BToIP AC 356 of FIG. 3, may be configured to encapsulate Bluetooth packets in a manner that indicates whether the Bluetooth packets are to be transmitted using the Bluetooth/BLE protocol or the BToIP protocol disclosed herein, as described with reference to FIG. 3. For example, the BToIP AC 716B may add headers to the Bluetooth packets indicating that the Bluetooth packets are to be transmitted to the peripheral device 620 using the BToIP protocol disclosed herein. The BToIP AC 716B may also be configured to decapsulate data packets received over the BToIP link and forward the decapsulated data to other layers of the Bluetooth stack 713. Further, although shown in the example of FIG. 7 as provided in the Host, in other implementations, the BToIP AC 716B may be provided within the WLAN subsystem 730.

The Bluetooth transport driver 716 is connected to the audio subsystem 720 via an audio and control link 760. In some instances, the audio and control link 760 may be used to send encoded audio/video data and control signals between the Bluetooth transport driver 716 and audio/video DSPs within the audio subsystem 720. The TCP/IP stack 717 allows the wireless device 700 to exchange data and control information with corresponding layers of a TCP/IP stack implemented in the peripheral device 620. For example, the TCP/IP stack 717 may be used to format frames or packets for transmission based on the TCP/IP transmission protocol, and may be used to extract data from frames or packets received based on the TCP/IP transmission protocol.

The WLAN stack 718 allows the wireless device 700 to exchange data and control information with corresponding layers of a WLAN stack implemented in the AP 780. For example, the WLAN stack 718 may be used to format frames or packets for transmission as IEEE 802.11-compliant PPDUs to the AP 780 over the WLAN channel 781, and may be used to extract data from IEEE 802.11-compliant PPDUs received from the AP 780 over the WLAN channel 781. In some instances, the WLAN stack 718, the TCP/IP stack 717, and the UART controller 719 may correspond to a Kernel space of the Application Processing subsystem 710. The UART 741, which is managed by the UART controller 719, provides a 3-wire interface (such as a transmit wire, a receive wire, and a ground wire) between the application processing subsystem 710 and the Bluetooth subsystem 730. A bus 731 provides a connection between the WLAN stack 718 and the WLAN subsystem 730. The bus 731 may be any suitable bus, signal line, or signaling that can be used to exchange PPDUs, control information, and other signals between the WLAN stack 718 and the WLAN subsystem 730. For example, in some aspects, the bus 731 may be a PCIe bus, soundwire, an Inter-IC Sound (I2S) bus, and the like.

The audio subsystem 720 may include encoders/decoders 722, one or more digital signal processors (DSPs) 724, and one or more codecs 726. The encoders/decoders 722 may be used to sample audio/video data extracted from one or more PPDUs received over one or more wireless channels of a WLAN and processed in the Application Processing block 710 based at least in part on a Bluetooth profile. In some implementations, the encoders/decoders 722 may partition the sampled audio/video data into payloads that can be embedded within one or more Bluetooth packets for transmission to the peripheral device 620 over the Bluetooth connection 630. In some other implementations, the encoders/decoders 722 may partition the sampled audio/video data into Ethernet frames or packets that can be encapsulated within IEEE 802.11-compliant PPDUs for transmission to the peripheral device 620 over the WLAN link 640. In some instances, the DSPs 724 and/or the codecs 726 may employ one or more encoding or decoding algorithms in conjunction with sampling the audio data.

The WLAN subsystem 730 may include a WLAN baseband circuit and firmware block 732, a MAC layer 734, and a PHY 736. The WLAN firmware may control operations of the WLAN subsystem 730, and may determine the protocol and configuration of one or both of the MAC layer 734 or the PHY 736. The WLAN baseband circuit may decode and/or process received data at baseband frequency, and may process and encode outgoing data at baseband frequency. The MAC layer 734 and the PHY 736 are collectively responsible for embedding outgoing data into MAC frames (such as MSDUs), encapsulating the MAC frames into data packets (such as PPDUs), and transmitting the data packets over the WLAN channel 781 to one or more other wireless devices. The MAC layer 734 and the PHY 736 are also collectively responsible for receiving data packets (such as PPDUs) over the WLAN channel 781, extracting data from the MAC frames encapsulated in the received data packets, and decoding the extracted data.

Specifically, when the WLAN subsystem 730 is in a receive mode, the PHY 736 may be used to receive, demodulate, and down-convert PPDUs received over the wireless channel 781, and the MAC layer 734 may be used to decode data encapsulated in the received PPDUs. The MAC layer 734 may also forward the decoded data to the application layer via the HCI 750. When the WLAN subsystem 730 is in a transmit mode, the MAC layer 734 may be used to construct and format MAC frames to carry data provided by the upper layers, and the PHY 736 may encapsulate the MAC frames within one or more PPDUs for transmission over the WLAN channel 781. In some aspects, the PHY 736 may define the mechanism for transmitting A/V bitstreams to the peripheral device 620 over the WLAN link 640 based on the BToIP protocol disclosed herein.

The Bluetooth subsystem 740 may include a Bluetooth baseband circuit and firmware block 742, an advanced audio distribution profile (A2DP) circuit 744, and a PHY 746. The Bluetooth baseband circuit and firmware block 742 may be used to generate baseband signals for constructing and deconstructing data frames based on the Bluetooth or BLE protocol. The Bluetooth baseband circuit and firmware block 742 may also be used to generate carrier signals for up-converting baseband signals during data transmissions and for down-converting received data signals to baseband. The A2DP circuit 744 may be used to control or manage an A2DP link between the wireless device 700 and the peripheral device 620. Specifically, when the Bluetooth subsystem 740 is in a receive mode, the PHY 746 can be used to receive, demodulate, and down-convert data packets received over the Bluetooth link or connection 748, and to forward the data packets to the application processing subsystem 710. When the Bluetooth subsystem 740 is in a transmit mode, the PHY 746 can be used to encapsulate data provided from the upper layers into one or more Bluetooth frames or packets for transmission to the peripheral device 620 over the Bluetooth link or connection 748.

In various aspects, the wireless device 700 may include a WLAN link 761 connected between the audio subsystem 720 and the WLAN subsystem 730. The WLAN link 761 may provide a direct link or channel over which Bluetooth-encoded audio/video data can be sent from the audio subsystem 720 to the WLAN subsystem 730 without passing through or accessing the Application Processing subsystem 710. Specifically, the WLAN link 761 may allow Bluetooth-encoded data to be forwarded directly from the audio subsystem 720 to the WLAN subsystem 730 for transmission to the peripheral device 620 over the WLAN link 640 without consuming processing cycles of the application processor, thereby avoiding latencies associated with the application processor and also avoiding latencies associated with the TCP/IP stack 717. In this way, the WLAN link 761 can reduce jitter and latency by directly routing Bluetooth-encoded data from the audio subsystem 720 to the WLAN subsystem 730.

In some instances, the wireless device 700 may transmit the data stream to the peripheral device 620 using a Target Wake Time (TWT) operation specified by the 802.11ax, 802.11be, and later amendments to the IEEE 802.11 family of wireless communication standards. In other instances, the wireless device 700 may transmit the data stream to the peripheral device 620 using a restricted-TWT (r-TWT) operation specified by the 802.11be and later amendments to the IEEE 802.11 family of wireless communication standards. The restricted TWT operation allows the wireless device 700 to establish one or more r-TWT service periods (SPs) that can be used to provide more predictable latency, reduced worst case latency, reduced jitter, and higher reliability for latency-sensitive traffic. For example, all peripheral devices that support restricted TWT operation that are TXOP holders outside of any r-TWT SP for which they are not a member to end their respective TXOPs before the start of the r-TWT SP. In some aspects, membership in a r-TWT SP may be reserved exclusively for peripheral devices associated with latency-sensitive traffic.

As discussed, although the ability to transmit Bluetooth-encoded data, particularly latency-sensitive traffic, over a WLAN channel or link may reduce latencies and increase throughput relative to similar transmissions over a Bluetooth connection, changes in the link quality of the WLAN channel and/or the Bluetooth connection may cause handover operations between the Bluetooth connection and the WLAN channel to inadvertently increase latencies and decrease throughput. In some instances, the wireless device may establish a Bluetooth connection with the peripheral device, and may transmit one or more Bluetooth-encoded data frames to the peripheral device over the Bluetooth connection. The wireless device may obtain an indication of one or more changes in the link metric of the Bluetooth connection, and may selectively initiate a handover operation based on the changes in the Bluetooth link metric. When the Bluetooth link metric is less than a first link metric threshold, the wireless device may initiate the handover operation, switch the communications with the peripheral device from the Bluetooth connection to the WLAN channel, and transmit additional Bluetooth-encoded data frames to the peripheral device over the WLAN channel.

Conversely, when the Bluetooth link metric is greater than the first link metric threshold, the wireless device may maintain the communications with the peripheral device on the Bluetooth connection, and may continue transmitting Bluetooth-encoded data frames to the peripheral device over the Bluetooth connection. In some instances, the Bluetooth link metric may include one or more of RSSI values of the first Bluetooth-encoded data frames, a quality of the Bluetooth connection, a data rate associated with the transmission of the first Bluetooth-encoded data frames over the Bluetooth connection, a PER associated with the transmission of the first Bluetooth-encoded data frames over the Bluetooth connection, an average channel access time associated with the Bluetooth connection, or a presence of concurrent DL and UL transmissions associated with the peripheral device.

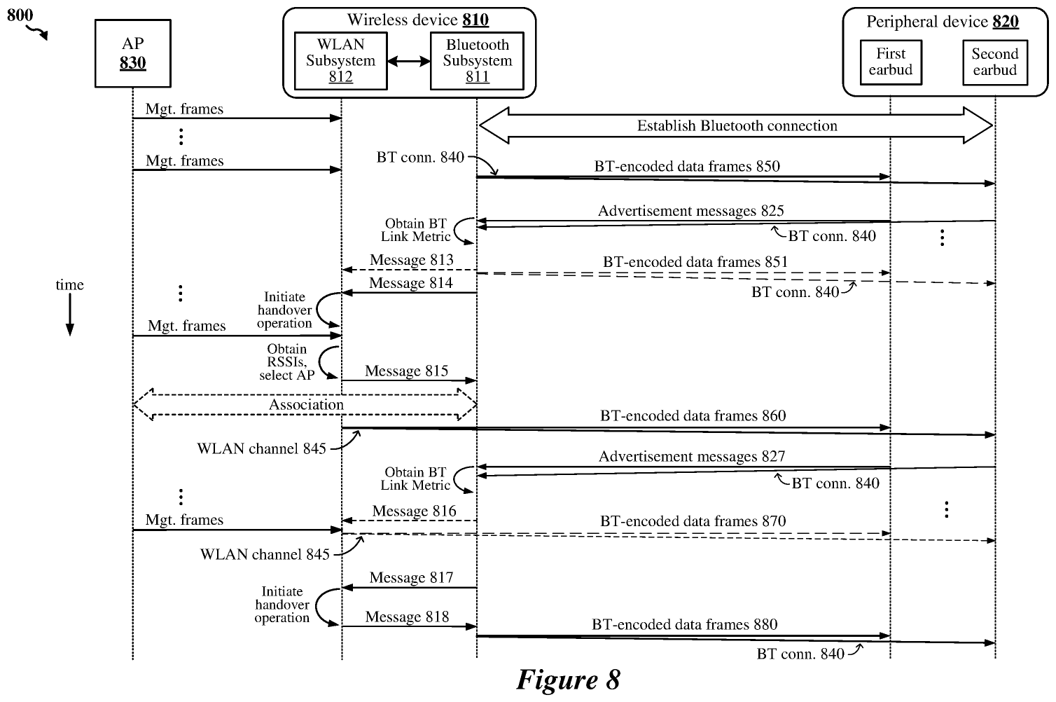

FIG. 8 shows a sequence diagram depicting an example wireless communication 800 that supports handover operations between a wireless device and a peripheral device, according to various aspects of the present disclosure. The wireless communication 800 may be performed between a wireless device 810, a peripheral device 820, and an AP 830. The wireless device 810 may be an example of the central device 102 of FIG. 1, the wireless device 200 of FIG. 2, the STA 410 of FIGS. 4A-4B, the STA 510 of FIGS. 5A-5B, the wireless device 610 of FIG. 6, or the wireless device 700 of FIG. 7. In some instances, the wireless device 810 may operate as a STA that can transmit data to and receive data from the AP 830 (or other APs not shown for simplicity) over one or more WLAN channels while implementing a softAP that can transmit data to and receive data from the peripheral device 820 over one or more WLAN channels.

The peripheral device 820 may be paired with the wireless device 810 (or the softAP operated by the wireless device 810) over a Bluetooth connection 840 according to one or more Bluetooth Specifications. In some aspects, the peripheral device 820 may be associated with the wireless device 810 (or the softAP operated by the wireless device 810) over a WLAN channel 845. The peripheral device 820 may be an example of one or more of the peripheral devices 104, 106, 108, 110, 112, or 114 of FIG. 1, the earbuds 420 of FIGS. 4A-4B, the earbuds 520 of FIGS. 5A-5B, or the peripheral device 620 of FIGS. 6-7. In the example of FIG. 8, the peripheral device 820 is a pair of earbuds that includes a first earbud and a second earbud. The first earbud is closer to the wireless device 810 than the second earbud, and therefore data packets transmitted by the wireless device 810 may arrive at the first earbud before arriving at the second earbud. Similarly, first earbud is closer to the AP 830 than the second earbud, and therefore data packets transmitted by the AP 830 may arrive at the first earbud before arriving at the second earbud.

The AP 830 may be any suitable access point, access terminal, base station, or gateway through which the wireless device 810 and the peripheral device 820 (or other wireless devices not shown for simplicity) can transmit data to and receive data from one or more other networks (such as through a backhaul connection).

The wireless device 810 may include at least a Bluetooth subsystem 811 and a WLAN subsystem 812 coupled to each other. Although not shown in FIG. 8 for simplicity, the Bluetooth subsystem 811 may include a Bluetooth host, a Bluetooth MAC, and a Bluetooth PHY. The WLAN subsystem 812 may include a WLAN host and WLAN firmware. The Bluetooth host may operate in conjunction with the Bluetooth MAC and PHY to allow the wireless device 810 to communicate with the peripheral device 820 over the Bluetooth connection 840. The WLAN host and WLAN firmware may be used to format, encode, and transmit WLAN-compliant packets (such as one or more of the PPDUs described in the IEEE 802.11 family of wireless communication standards) to one or both of the peripheral device 820 and the AP 830 over the WLAN channel 845. The WLAN host and WLAN firmware may also be used to receive, decode, and extract data packets received over the WLAN channel 845 from one or both of the peripheral device 820 and the AP 830.

In the example of FIG. 8, the AP 830 periodically broadcasts or transmits management frames over the WLAN channel 845. The management frames may carry information that can be used by wireless devices (such as the wireless device 810 and the peripheral device 820) to initiate association and authentication procedures with the AP 830. The management frames may also carry timing information (such as a current TSF value of the AP 830) that can be used by the wireless devices to synchronize their respective local TSF timers with the current TSF value of the AP 830. For example, in some instances, the management frames may be beacon frames broadcast by the AP 830 according to Target Beacon Transmission Times (TBTTs) or Beacon Intervals. In other instances, the management frames may be association response frames, reassociation response frames, probe response frames, or FILS discovery frames.

In some implementations, the wireless device 810 may determine or obtain WLAN channel metrics based on one or more management frames received from each of a plurality of nearby APs (including the AP 830). The WLAN channel metrics may be indicative of the quality, latency, throughput, congestion, and/or interference levels associated with respective communication links on which nearby APs (including the AP 830) operate. For example, in some aspects, the WLAN channel metrics may include (but are not limited to) RSSI values, PERs, channel quality indicators (CQIs), and channel contention times. In some other aspects, the WLAN channel metrics may be determined or otherwise obtained from other types of frames (such as action frames, control frames, or data frames) transmitted by the AP 830.

The wireless device 810 and the peripheral device 820 may establish a Bluetooth connection with each other based on one or more of the Bluetooth Specifications provided by the Bluetooth Special Interest Group (the Bluetooth SIG). The Bluetooth connection may be any suitable Bluetooth-compliant including (but not limited to) an Asynchronous Connection-Less (ACL) link, a Logical Link Control and Adaptation Protocol (L2CAP) link, an Advanced Audio Distribution Profile (A2DP) link, a Synchronous Connection-Oriented (SCO) link, or an Isochronous (ISO) link.

After connection establishment, the wireless device 810 transmits one or more Bluetooth-encoded data frames 850 to the peripheral device 820 over the Bluetooth connection 840. In some aspects, the wireless device 810 may transmit the Bluetooth-encoded data frames 850 to the peripheral device 820 during one or more connection events associated with a CIS or a BIS. In some aspects, the Bluetooth-encoded data frames 850 may be transmitted over the Bluetooth connection 840 to the first and second earbuds, concurrently. In other aspects, the Bluetooth-encoded data frames 850 may be transmitted over the Bluetooth connection 840 to the first earbud, and the first earbud may send the Bluetooth-encoded data frames 850 to the second earbuds.

In some instances, the Bluetooth-encoded data frames 850 may carry audio data that is part of an audio stream. In other instances, the Bluetooth-encoded data frames 850 may carry video data that is part of a video stream. In various aspects, the Bluetooth-encoded data frames 850 may carry latency-sensitive traffic as defined by the 802.11be amendments to the IEEE 802.11 standard. In some aspects, one or both of the softAP operated by the wireless device 810 and the AP 830 may establish one or more r-TWT SPs on the WLAN channel for latency-sensitive traffic. The peripheral device 820 receives the Bluetooth-encoded data frames 850 over the Bluetooth connection 840, and may extra the payload data, for example, to play for a user.

In some implementations, the peripheral device 820 may periodically broadcast Bluetooth advertisement messages 825 over the shared wireless medium that includes at least the Bluetooth connection 840. The Bluetooth advertisement messages 825 may indicate the presence of the peripheral device 820, and may include discovery and capability information that can be used by other Bluetooth-enabled devices to seek connection establishment with the peripheral device 820.

Aspects of the present disclosure recognize that the Bluetooth advertisement messages 825 broadcast by the peripheral device 820 may be indicative of the link quality of the Bluetooth connection 840. In some instances, a link metric of the Bluetooth connection 840 can be determined or obtained based on the Bluetooth advertisement messages 825 broadcast over the shared wireless medium. The Bluetooth link metric may be any suitable indicator of a quality, latency, interference level, or throughput of the Bluetooth connection 840. In various aspects, the Bluetooth link metric may include received signal strengths, quality indicators of the Bluetooth connection 840, the data rate used for transmissions over the Bluetooth connection 840, a PER of data transmissions over the Bluetooth connection 840, an average channel access time associated with the Bluetooth connection 840, or a presence of concurrent DL transmissions to and UL transmissions from the peripheral device 820.

In various implementations, the wireless device 810 may compare the Bluetooth link metric with one or more link metric thresholds, and may selectively switch communications with the peripheral device 820 from the Bluetooth connection 840 to the WLAN channel 845 based on the comparison. The comparison may be performed by the Bluetooth subsystem 811, the WLAN subsystem 812, or another suitable component of the wireless device 810. For example, in some instances, when the Bluetooth link metric is greater than a first link metric threshold, the wireless device 810 may continue transmitting Bluetooth-encoded data frames to the peripheral device 820 over the Bluetooth connection 840. As such, the wireless device 810 does not initiate any handover operations (at least at the time of the comparison), and communications with the peripheral device 820 are maintained on the Bluetooth connection 840.

For implementations in which the Bluetooth subsystem 811 compares the Bluetooth link metric with the one or more link metric thresholds, the Bluetooth subsystem 811 may send a message 813 to the WLAN subsystem 812 indicating that the Bluetooth link metric is greater than the first link metric threshold. In response to the message 813, the WLAN subsystem 812 does not initiate the handover operation. Thereafter, the Bluetooth subsystem 811 may transmit additional Bluetooth-encoded data frames 851 to the peripheral device 820 over the Bluetooth connection 840. The transmission of Bluetooth-encoded data frames over the Bluetooth connection 840 to the peripheral device 820 may continue, for example, until the next instance during which the link metric of the Bluetooth connection 840 is obtained and compared with the one or more link metric thresholds.

Conversely, when the Bluetooth link metric is less than the first link metric threshold, the wireless device 810 may initiate a handover operation during which communications with the peripheral device 820 are switched from the Bluetooth connection 840 to the WLAN channel 845. For implementations in which the Bluetooth subsystem 811 compares the Bluetooth link metric with the one or more link metric thresholds, the Bluetooth subsystem 811 may send a message 814 to the WLAN subsystem 812 indicating that the Bluetooth link metric is less than the first link metric threshold. The WLAN subsystem 812 receives the message 814, and initiates the handover operation. In some instances, the first link metric threshold may be set or configured to a value below which communications transmitted to the peripheral device 820 over the Bluetooth connection 840 are not of a quality acceptable to a user of the earbuds (or that a poor quality of the corresponding audio, video, or data stream may adversely affect user experience. As such, the wireless device 810 switches communications with the peripheral device 820 from the Bluetooth connection 840 to the WLAN channel 845.

In addition, or in the alternative, the Bluetooth link metric may be, or may indicate, a level of co-existence interference between the Bluetooth connection 840 and the WLAN channels associated with nearby APs. For example, in some instances, the wireless device 810 may initiate a respective handover operation to switch the communications from the Bluetooth connection 840 to the WLAN channel 845 based at least in part on the level of co-existence interference being greater than an interference threshold. In other instances, the wireless device 810 may not initiate the respective handover operation based at least in part on the level of co-existence interference being less than the interference threshold.

In some instances, the wireless device 810 may determine or obtain RSSI values of the Bluetooth advertisement messages 825 broadcast on the shared wireless medium, and may compare an average RSSI value of a group of the Bluetooth advertisement messages 825 with one or more RSSI thresholds to determine whether or not to initiate the handover operation from the Bluetooth connection 840 to the WLAN channel 845. For example, when the average RSSI value is greater than a first RSSI threshold, which may indicate that the Bluetooth link quality is acceptable, the wireless device 810 maintains communication with the peripheral device 820 on the Bluetooth connection 840. Conversely, when the average RSSI value is less than the first RSSI threshold, which may indicate that the Bluetooth link quality is not acceptable (e.g., to a suer), the wireless device 810 may initiate the handover operation from the Bluetooth connection 840 to the WLAN channel 845.

In some implementations, the wireless device 810 may select or identify the most-suitable AP with which to associate as part of the handover operation. As used herein, the “most-suitable AP” may refer to the AP that can facilitate the transmission of Bluetooth-encoded data frames over a WLAN channel with the lowest latency, the lowest jitter, and/or the greatest throughput. For example, although the example of FIG. 8 shows only one AP 830, in other implementations, there may be a plurality of nearby APs (e.g., within wireless range of the wireless device 810 and/or the peripheral device 820). In these implementations, the wireless device 810 may select one of the nearby candidate APs as part of the handover operation, and then switch communications with the peripheral device 820 from the Bluetooth connection 840 to the WLAN channel associated with the selected AP.

The wireless device 810 may use channel metrics associated with management frames broadcast by the nearby APs to select or identify the most-suitable AP with which to associate (or at least to manage communications between the wireless device 810 and the peripheral device 820). For example, in some instances, the wireless device 810 may obtain RSSI values of beacon frames (or other management frames) broadcast by each of a plurality of candidate APs, and determine which of the candidate APs is associated with the greatest RSSI values. In other instances, the wireless device 810 may use other channel metrics of management frames (or other types of frames) broadcast or transmitted by the candidate APs to select or identify the most-suitable AP with which to associate. In some aspects, the WLAN subsystem 812 may send a message 815 to the Bluetooth subsystem 811 indicating that communications with the peripheral device 820 are being switched from the Bluetooth connection 840 to a WLAN channel. The Bluetooth subsystem 811 receives the message 815, and discontinues the transmission of Bluetooth-encoded data frames over the Bluetooth connection 840 to the peripheral device 820.

In some aspects, the wireless device 810 may associate and authenticate with the selected AP (if not already associated), and then transmit Bluetooth data to the peripheral device 820 over the WLAN channel. In the example of FIG. 8, the wireless device 810 associates with the AP 830, and then transmits one or more Bluetooth-encoded data frames 860 to the peripheral device 820 over the WLAN channel 845 associated with the AP 830. In some instances, the Bluetooth-encoded data frames 860 are encapsulated within WLAN-compliant PPDUs for transmission over the WLAN channel 845.

After receiving the Bluetooth-encoded data frames 860, the peripheral device 820 broadcasts additional Bluetooth advertisement messages 827 over the shared wireless medium. As discussed, the wireless device 810 may determine or obtain RSSI values of the broadcast Bluetooth advertisement messages 827, and may compare an average RSSI value of a group of the Bluetooth advertisement messages 827 with the one or more RSSI thresholds to determine whether or not to initiate another handover operation. For example, when the average Bluetooth RSSI value is less than a second RSSI threshold, which may indicate that the Bluetooth link quality is still not acceptable, the wireless device 810 maintains communications with the peripheral device 820 on the WLAN channel 845. For implementations in which the Bluetooth subsystem 811 determines that the average Bluetooth RSSI value is less than the second RSSI threshold, the Bluetooth subsystem 811 may send a message 817 for the WLAN subsystem 812 to maintain the communications with the peripheral device 820 on the WLAN channel 845. The WLAN subsystem 812 receives the message 817, and does not initiate the handover operation. Thereafter, the WLAN subsystem 812 may transmit additional Bluetooth-encoded data frames 870 to the peripheral device 820 over the Bluetooth connection 840. As discussed, the Bluetooth-encoded data frames 870 may be encapsulated within WLAN-compliant PPDU transmitted over the WLAN channel 840 to the peripheral device 820.

Conversely, when the average Bluetooth RSSI value is greater than the second RSSI threshold, which may indicate that the Bluetooth link quality is acceptable, the wireless device 810 initiates a handover operation during which communications with the peripheral device 820 are switched from the WLAN channel 845 to the Bluetooth connection 840. For implementations in which the Bluetooth subsystem 811 determines that the average Bluetooth RSSI value is greater than the second RSSI threshold, the Bluetooth subsystem 811 may send a message 818 to the WLAN subsystem 812 indicating that the Bluetooth connection 840 has an acceptable link quality. The WLAN subsystem 812 receives the message 818, and initiates a handover operation during which communications with the peripheral device 820 are switched from the WLAN channel 845 to the Bluetooth connection 840. After the handover operation, the Bluetooth subsystem 811 may transmit additional Bluetooth-encoded data frames 880 to the peripheral device 820 over the Bluetooth connection 840.

In some implementations, the wireless device 810 may determine whether or not to initiate handover operations disclosed herein based at least in part on a distance between the peripheral device 820 and the wireless device 810. For example, in some instances, the wireless device 810 may initiate a respective handover operation based on the distance between the peripheral device 820 and the wireless device 810 being greater than a value. In other instances, the wireless device 810 may initiate the respective handover operation based on the distance between the peripheral device 820 and the wireless device 810 increasing by more than an amount. Conversely, the wireless device 810 may refrain from initiating the respective handover operation based on the distance between the peripheral device 820 and the wireless device 810 being less than the value, or may refrain from initiating the respective handover operation based on the distance not increasing by more than the amount.

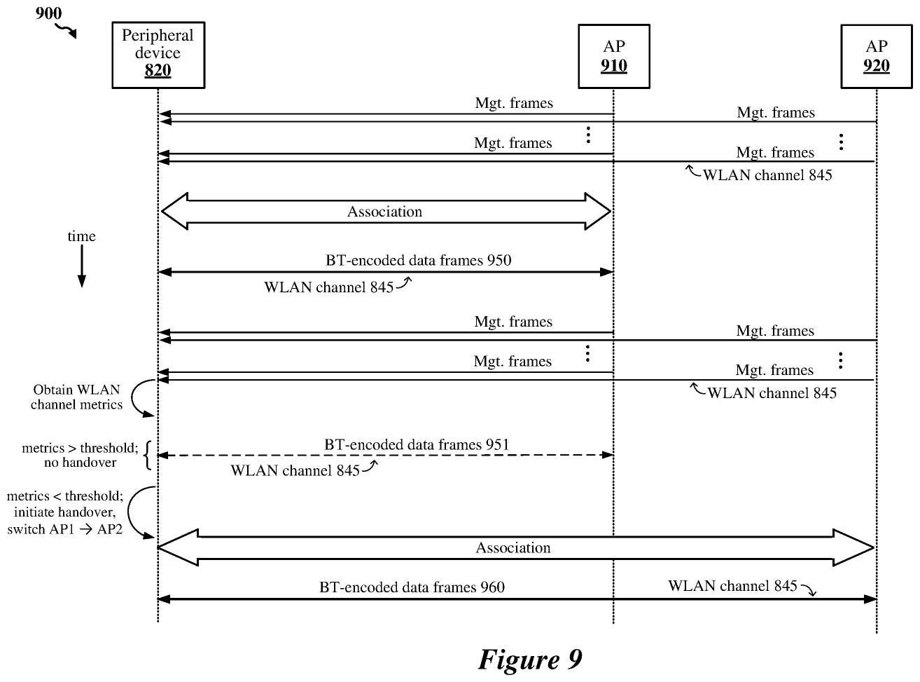

FIG. 9 shows a sequence diagram depicting an example wireless communication 900 that supports handover operations between a peripheral device and a wireless device, according to various aspects of the present disclosure. The wireless communication 900 may be performed between a first AP 910, a second AP 920, and the peripheral device 820 described with reference to FIG. 8. In some instances, the first AP 910 and the second AP 920 belong to the same basic service set (BSS) or the same extended BSS (ESS), and may operate on one or more wireless channels such as the WLAN channel 845.

Although not shown for simplicity, the peripheral device 820 may be paired with a softAP over a Bluetooth connection (not shown for simplicity). In some instances, the softAP may be implemented by or associated with the wireless device 810 described with reference to FIG. 9. The first and second APs 910 and 920 may be any suitable access point, access terminal, base station, or gateway through which the peripheral device 820 (and other wireless devices not shown for simplicity) can transmit data to and receive data from one or more other networks (such as through a backhaul connection). In some instances, the peripheral device 820 may be associated with one of the first AP 910 or the second AP 920 over the WLAN channel 845.

In the example of FIG. 9, each of the first AP 910 and the second AP 920 may periodically broadcast management frames over a shared wireless medium that includes at least the WLAN channel 845. As discussed, the management frames may carry information that can be used by wireless devices (such as the peripheral device 820) to initiate association and authentication procedures with the respective APs 910 and 920. The management frames may also carry timing information (such as a current TSF value of the respective AP) that can be used by the wireless devices to synchronize their respective local TSF timers with the current TSF value of the respective AP.

In some implementations, the peripheral device 820 associates with the first AP 910 on the WLAN channel 845. After the association and related authentication procedures are completed, the peripheral device 820 exchanges one or more Bluetooth-encoded data frames 950 with the first AP 910 over the WLAN channel 845. The peripheral device 820 may determine or obtain a link metric of the WLAN channel 845, and may selectively initiate a handover operation based on the WLAN link metric. For example, when the WLAN link metric indicates a stable or improving WLAN link quality, the peripheral device 820 may maintain communications with the first AP 910 and not perform a handover operation. Specifically, the peripheral device 820 may compare the WLAN link metric with one or more WLAN link metric thresholds, and may maintain the communications with the first AP 910 when the WLAN link metric is greater than a respective WLAN link metric threshold. Thereafter, the peripheral device 820 may continue exchanging Bluetooth-encoded data frames 951 with the first AP 910 over the WLAN channel 845.

Conversely, when the WLAN link metric indicates a declining or deteriorating WLAN link quality, the peripheral device 820 may initiate the handover operation. Specifically, when the WLAN link metric is less than the respective WLAN link metric threshold, the peripheral device 820 may initiate the handover operation and switch communications from the first AP 910 to the second AP 920. In some aspects, the peripheral device 820 switches communications from the first AP 910 to the second AP 920 when the WLAN link metrics indicate a decrease in RSSI values of the Bluetooth-encoded data frames 950 or an increase in the PERs of the Bluetooth-encoded data frames 950. Thereafter, the peripheral device 820 may exchange additional Bluetooth-encoded data frames 960 with the second AP 920 over the WLAN channel 845.

In other implementations, the WLAN link metric may also include one or more of a quality of the Bluetooth connection 840, a data rate associated with the transmission of the Bluetooth-encoded data frames over the Bluetooth connection 840, an average channel access time associated with the Bluetooth connection 840, or a presence of concurrent DL and UL transmissions associated with the peripheral device 820.

In some other implementations, the wireless device 810 may determine or obtain RSSI values of the Bluetooth advertisement messages 825 broadcast on the shared wireless medium, and may compare an average RSSI value of a group of the Bluetooth advertisement messages 825 with one or more RSSI thresholds to determine whether or not to initiate the handover operation from the Bluetooth connection 840 to the WLAN channel 845. For example, when the average RSSI value is greater than a first RSSI threshold, which may indicate that the Bluetooth link quality is acceptable, the wireless device 810 maintains communication with the peripheral device 820 on the Bluetooth connection 840. Conversely, when the average RSSI value is less than the first RSSI threshold, which may indicate that the Bluetooth link quality is not acceptable (e.g., to a suer), the wireless device 810 may initiate the handover operation from the Bluetooth connection 840 to the WLAN channel 845.

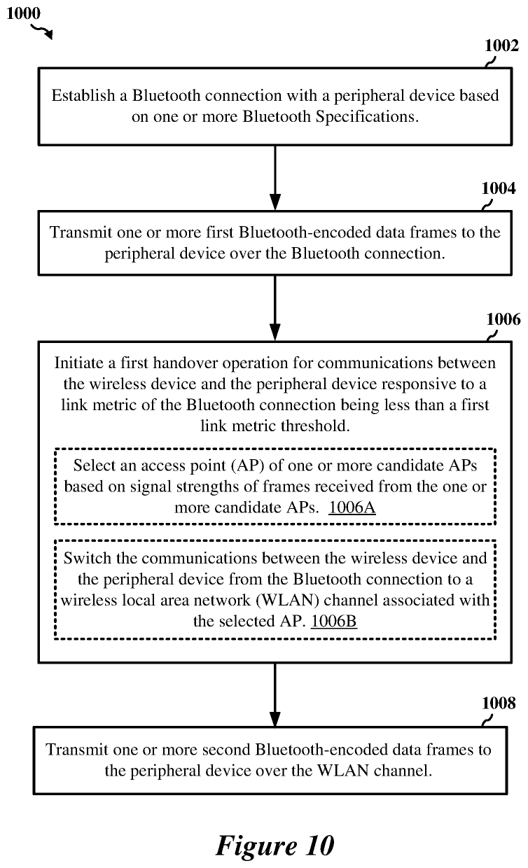

FIG. 10 shows a flowchart illustrating an example operation 1000 for wireless communication that supports handover operations between a wireless device and a peripheral device, according to various aspects of the present disclosure. The operation 1000 may be performed by a wireless device such as the central device 102 of FIG. 1, the wireless device 200 of FIG. 2, the STA 410 of FIGS. 4A-4B, the STA 510 of FIGS. 5A-5B, the wireless device 610 of FIG. 6, or the wireless device 700 of FIG. 7. In some implementations, the operation 1000 may be performed by a wireless device that can operate on a WLAN channel or link as a STA while also operating as a softAP paired with a peripheral device over a Bluetooth connection. In various implementations, the wireless device may be a smartphone, handset, or other suitable device that can send audio, video, and other traffic streams to the peripheral device. In some instances, the peripheral device may be or may include headphones, headsets, earbuds, or other remote devices. In some aspects, the peripheral device may be an example of one or more of the peripheral devices 104, 106, 108, 110, 112, or 114 of FIG. 1, the earbuds 420 of FIGS. 4A-4B, the earbuds 520 of FIGS. 5A-5B, or the peripheral device 620 of FIGS. 6-7.

For example, at 1002, the wireless device establishes a Bluetooth connection with a peripheral device based on one or more Bluetooth Specifications. At 1004, the wireless device transmits one or more first Bluetooth-encoded data frames to the peripheral device over the Bluetooth connection. At 1006, the wireless device initiates a first handover operation for communications between the wireless device and the peripheral device responsive to a link metric of the Bluetooth connection being less than a first link metric threshold. In some instances, the wireless device may initiate the handover operation by selecting an access point (AP) of one or more candidate APs based on signal strengths of frames received from the one or more candidate APs (at 1006A), and switching the communications between the wireless device and the peripheral device from the Bluetooth connection to a wireless local area network (WLAN) channel associated with the selected AP (at 1006B). At 1008, the wireless device transmits one or more second Bluetooth-encoded data frames to the peripheral device over the WLAN channel. In some instances, the one or more second Bluetooth-encoded data frames are encapsulated within physical layer convergence protocol (PLCP) protocol data units (PPDUs) compliant with the IEEE 802.11 family of wireless communication standards for transmission to the peripheral device over the WLAN channel.

In various implementations, the peripheral device includes a first earbud and a second earbud, each of the first and second earbuds being associated with the softAP, and each of the first and second earbuds being paired with the softAP via the Bluetooth connection. In some instances, the WLAN channel may be one or more wireless channels in a 2.4 GHz frequency band, a 5 GHz frequency band, or a 6 GHz frequency band. In other instances, the WLAN channel may include at least one of a P2P link, a TDLS link, a Wi-Fi Direct link, a link associated with a Group Owner (GO), or a link associated with a Neighborhood Area Network (NAN).

In some implementations, the link metric may include one or more of RSSI values of the first Bluetooth-encoded data frames, a quality of the Bluetooth connection, a data rate associated with the Bluetooth connection, a packet error rate (PER) associated with the Bluetooth connection, an average channel access time associated with the Bluetooth connection, or a presence of concurrent DL and UL transmissions associated with the peripheral device.

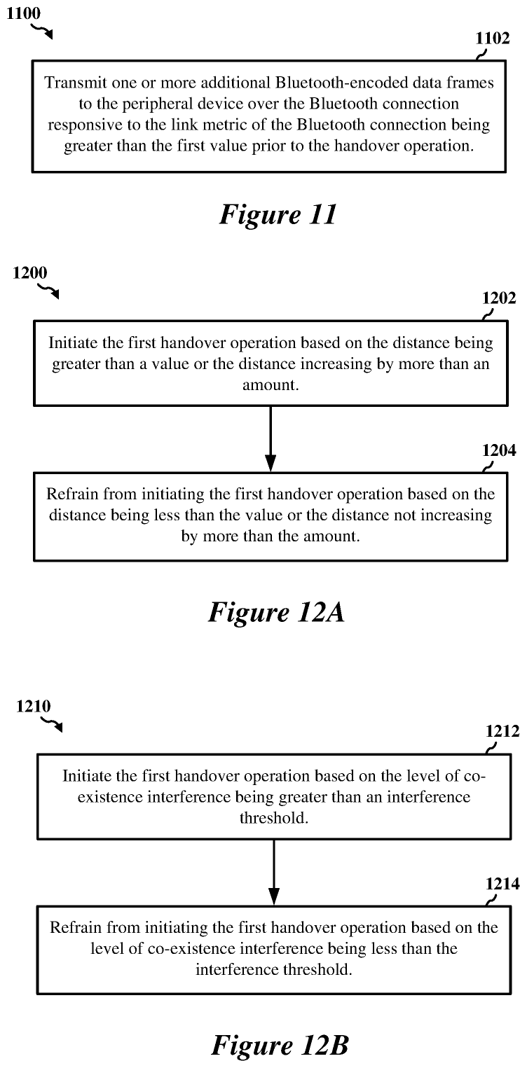

FIG. 11 shows a flowchart illustrating another example operation 1100 for wireless communication that supports handover operations for a wireless device and an associated peripheral device, according to various aspects of the present disclosure. In some instances, the operation 1100 may be performed after the operation 1000 of FIG. 10. For example, at 1102, the wireless device transmits one or more additional Bluetooth-encoded data frames to the peripheral device over the Bluetooth connection, without initiating the first handover operation, responsive to the link metric of the Bluetooth connection being greater than the first link metric threshold. In this way, the wireless device can maintain communications with the peripheral device over the Bluetooth connection as long as the link metric indicates at least a certain quality or throughput of the Bluetooth connection.

FIG. 12A shows a flowchart illustrating an example operation 1200 for wireless communication that supports initiating an example handover operation disclosed herein, according to various aspects of the present disclosure. In some instances, the operation 1200 may be one example of initiating the first handover operation at 1006 of FIG. 10. As discussed, in some instances, initiating the first handover operation may also be based on a distance between the peripheral device and the wireless device. For example, in some instances, the wireless device may initiate the first handover operation based on the distance being greater than a value or the distance increasing by more than an amount, at 1202. In other instances, the wireless device may refrain from initiating the first handover operation based on the distance being less than the value or the distance not increasing by more than the amount, at 1204.

FIG. 12B shows a flowchart illustrating another example operation 1210 for wireless communication that supports initiating an example handover operation disclosed herein, according to various aspects of the present disclosure. In some instances, the operation 1210 may be another one example of initiating the first handover operation at 1006 of FIG. 10. As discussed, in some instances, the link metric may be a level of co-existence interference between the Bluetooth connection and respective WLAN channels associated with the one or more candidate APs. For example, in some instances, the wireless device may initiate the first handover operation based on the level of co-existence interference being greater than an interference threshold, at 1212. In other instances, the wireless device may refrain from initiating the first handover operation based on the level of co-existence interference being less than the interference threshold, at 1214.

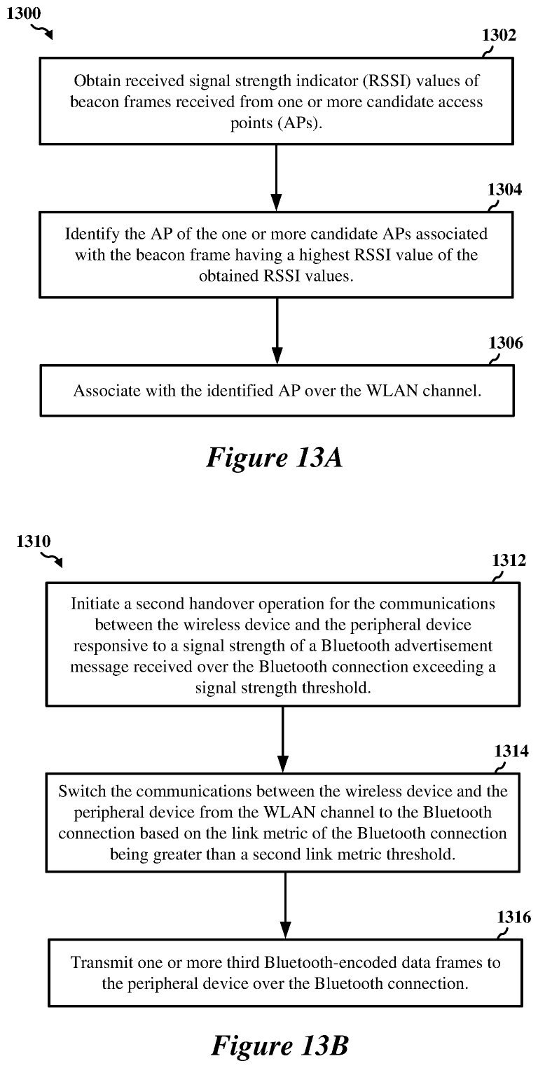

FIG. 13A shows a flowchart illustrating an example operation 1300 for wireless communication that supports initiating another example handover operation disclosed herein, according to various aspects of the present disclosure. In some instances, the operation 1300 may be one example of selecting the AP at 1006A of FIG. 10. For example, at 1302, the wireless device obtains received signal strength indicator (RSSI) values of beacon frames received from one or more candidate access points (APs). At 1304, the wireless device identifies the AP of the one or more candidate APs associated with the beacon frame having a highest RSSI value of the obtained RSSI values. At 1306, the wireless device associates with the identified AP over the WLAN channel.

FIG. 13B shows a flowchart illustrating another example operation 1310 for wireless communication that supports initiating another example handover operation disclosed herein, according to various aspects of the present disclosure. In some instances, the operation 1310 may be performed after the example operation 1000 of FIG. 10. For example, at 1312, the wireless device initiates a second handover operation for the communications between the wireless device and the peripheral device responsive to a signal strength of a Bluetooth advertisement message received over the Bluetooth connection exceeding a signal strength threshold. At 1314, the wireless device switches the communications between the wireless device and the peripheral device from the WLAN channel to the Bluetooth connection based on the link metric of the Bluetooth connection being greater than a second link metric threshold. At 1316, the wireless device transmits one or more third Bluetooth-encoded data frames to the peripheral device over the Bluetooth connection. In some aspects, the Bluetooth advertisement message may be received from the peripheral device 820. In other aspects, one or more Bluetooth advertisement messages may be received over the Bluetooth connection from other Bluetooth-enabled devices.

In some implementations, switching the communications from the WLAN channel to the Bluetooth connection is further based on one or more of a quality of the Bluetooth connection, a data rate associated with the Bluetooth connection, a packet error rate (PER) associated with the Bluetooth connection, an average channel access time associated with the Bluetooth connection, a presence of concurrent downlink (DL) and uplink (UL) transmissions associated with the peripheral device, or a level of cross-link interference associated with the concurrent DL and UL transmissions.

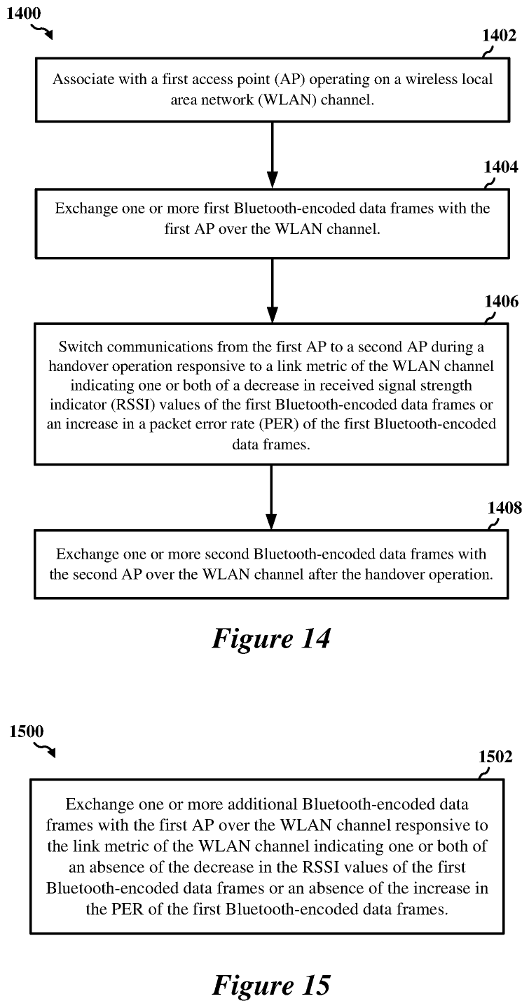

FIG. 14 shows a flowchart illustrating an example operation 1400 for wireless communication that supports handover operations between a peripheral device and a wireless device, according to various aspects of the present disclosure. The operation 1400 may be performed by a peripheral device such as one of the peripheral devices 104, 106, 108, 110, 112, or 114 of FIG. 1, the earbuds 420 of FIGS. 4A-4B, the earbuds 520 of FIGS. 5A-5B, or the peripheral device 620 of FIGS. 6-7. In some instances, the peripheral device may be or may include headphones, headsets, earbuds, or other remote devices. The wireless device may be one example of the central device 102 of FIG. 1, the wireless device 200 of FIG. 2, the wireless device 410 of FIGS. 4A-4B, the wireless device 510 of FIGS. 5A-5B, the wireless device 610 of FIG. 6, or the wireless device 700 of FIG. 7. In various aspects, the wireless device may operate on a WLAN channel or link as a STA while also operating as a softAP paired with the peripheral device over a Bluetooth connection. In some aspects, the wireless device may be a smartphone, handset, or other suitable device that can send audio, video, and other traffic streams to the peripheral device.

For example, at 1402, the peripheral device associates with a first access point (AP) operating on a wireless local area network (WLAN) channel. At 1404, the peripheral device exchanges one or more first Bluetooth-encoded data frames with the first AP over the WLAN channel. At 1406, the peripheral device switches communications from the first AP to a second AP during a handover operation responsive to a link metric of the WLAN channel indicating one or both of a decrease in received signal strength indicator (RSSI) values of the first Bluetooth-encoded data frames or an increase in a packet error rate (PER) of the first Bluetooth-encoded data frames. At 1408, the peripheral device exchanges one or more second Bluetooth-encoded data frames with the second AP over the WLAN channel after the handover operation. In various aspects, the first AP and the second AP belong to the same basic service set (BSS) or extended BSS (ESS).

In some implementations, the first and second Bluetooth-encoded data frames are encapsulated within physical layer convergence protocol (PLCP) protocol data units (PPDUs) compliant with the IEEE 802.11 family of wireless communication standards for transmission to the peripheral device over the WLAN channel. In some instances, the wireless device transmits the PPDUs carrying the encapsulated first and second Bluetooth-encoded data frames over the WLAN channel based on one or more amendments to the IEEE 802.11 family of wireless communication standards.

In various implementations, the peripheral device includes a first earbud and a second earbud, each of the first earbud and the second earbud being associated with the softAP, and each of the first earbud and the second earbud being paired with the softAP via the Bluetooth connection. In some instances, the WLAN link includes one or more wireless channels in a 2.4 GHz frequency band, a 5 GHz frequency band, or a 6 GHz frequency band. In other instances, the WLAN link includes at least one of a P2P link, a TDLS link, a Wi-Fi Direct link, a link associated with a Group Owner (GO), or a link associated with a Neighborhood Area Network (NAN).

In some implementations, the link metric includes one or more of received signal strength indicator (RSSI) values of the first Bluetooth-encoded data frames, a quality of the Bluetooth connection, a data rate associated with the transmission of the first Bluetooth-encoded data frames over the Bluetooth connection, a packet error rate (PER) associated with the transmission of the first Bluetooth-encoded data frames over the Bluetooth connection, an average channel access time associated with the Bluetooth connection, or a presence of concurrent downlink (DL) and uplink (UL) transmissions associated with the peripheral device.

FIG. 15 shows a flowchart illustrating another example operation 1500 for wireless communication that supports handover operations between a peripheral device and a wireless device, according to various aspects of the present disclosure. In some instances, the operation 1500 may be performed after the example operation 1400 of FIG. 14. For example, at 1502, the peripheral device exchanges one or more additional Bluetooth-encoded data frames with the first AP over the WLAN channel responsive to the link metric of the WLAN channel indicating one or both of an absence of the decrease in the RSSI values of the first Bluetooth-encoded data frames or an absence of the increase in the PER of the first Bluetooth-encoded data frames.

In some implementations, switching the communications may also be based on respective distances between the peripheral device and each of the first AP and the second AP. In some instances, switching the communications may also be based, at least in part, on a location of the peripheral device being outside a wireless coverage area of the first AP, on the location of the peripheral device being outside a wireless coverage area of the softAP, on the location of the peripheral device being within a wireless coverage area of the second AP, or any combination thereof.

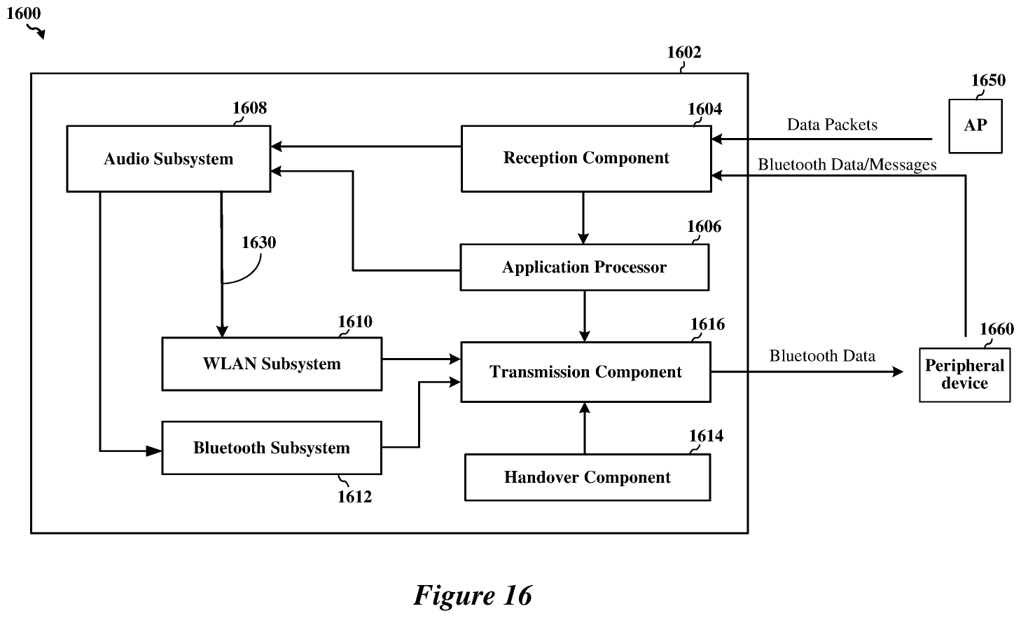

FIG. 16 is a conceptual data flow diagram 1600 illustrating the data flow between different means and/or components of an example apparatus 1602. In some implementations, the apparatus may be a wireless device that operates as a STA that can associate with an AP 1650 while also operating as a softAP with which one or more peripheral devices 1660 can be associated. The apparatus 1602 includes a reception component 1604 that receives data packets from the AP 1650. The apparatus 1602 also includes an application processor 1606, an audio subsystem 1608, a WLAN subsystem 1610, a Bluetooth subsystem 1612, a handover component 1614, and a transmission component 1616.

The application processor 1606 extracts audio or video data from the data packets received from the AP 1650, attaches or applies a Bluetooth profile to the extracted audio or video data, and routes the extracted audio or video data to the audio subsystem 1608. The audio subsystem 1608 encodes the audio or video data, and routes the encoded audio or video data to the WLAN subsystem 1610. The WLAN subsystem 1610 embeds the encoded audio or video data into Bluetooth frames, and encapsulates the Bluetooth frames within one or more IEEE 802.11-compliant data packets. The Bluetooth subsystem 1612 can establish a Bluetooth session or connection with the peripheral device 1660, and can facilitate the transmission of data and other information to the peripheral device 1660 using Bluetooth communications (e.g., as one or more Bluetooth frames or packets).

The transmission component 1616 is coupled to the WLAN subsystem 1610 and the Bluetooth subsystem 1612, and may be used to transmit frames or packets provided by the WLAN subsystem 1610 and/or the Bluetooth subsystem 1612 to one or both of the AP 1650 and the peripheral device 1660. In some implementations, the transmission component 1616 may transmit data packets containing encoded audio or video data over a Wi-Fi link or channel to the peripheral device 1660. In some instances, the transmission component 1616 may also transmit data to the peripheral device 1660 over a Bluetooth link or connection. In some other instances, various aspects of the transmission component 1616 may be integrated within each of the WLAN subsystem 1610 and the Bluetooth subsystem 1612.

The apparatus 1602 may include additional components that perform each of the blocks of the algorithm in the flowcharts of FIGS. 10-15. As such, each block in the flowcharts of FIGS. 10-15 may be performed by a component and the apparatus 1602 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

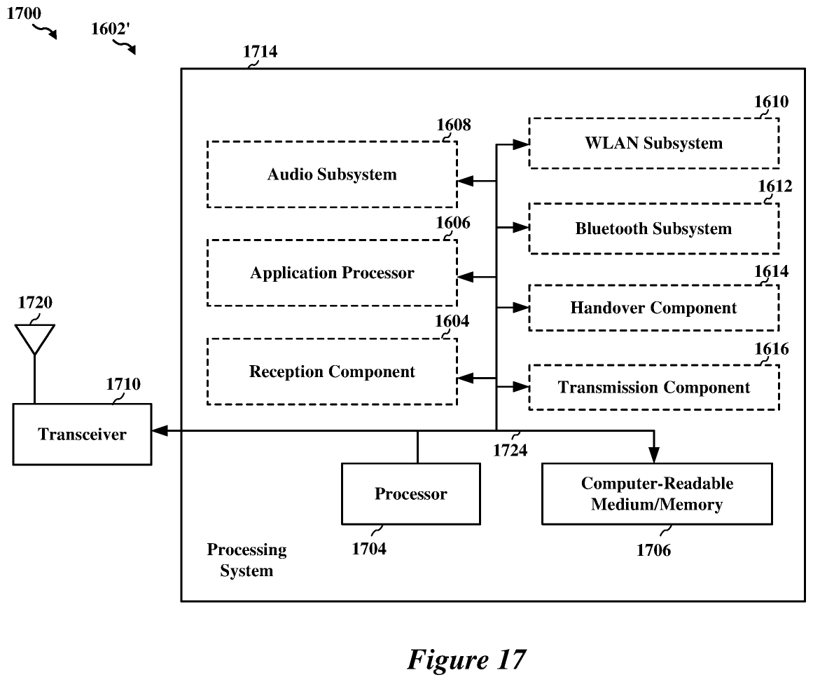

FIG. 17 is a diagram 1700 illustrating an example of a hardware implementation for an apparatus 1602′ employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware components, represented by the processor 1704, the components 1604, 1606, 1608, 1610, 1612, 1614, and 1616 and the computer-readable medium/memory 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus over a transmission medium. The transceiver 1710 receives a signal from the one or more antennas 1720, extracts information from the received signal, and provides the extracted information to the processing system 1714, specifically the reception component 1604. In addition, the transceiver 1710 receives information from the processing system 1714, specifically the transmission component 1616, and based on the received information, generates a signal to be applied to the one or more antennas 1720. The processing system 1714 includes a processor 1704 coupled to a computer-readable medium/memory 1706. The processor 1704 is responsible for general processing, including the execution of software stored on the computer-readable medium/memory 1706. The software, when executed by the processor 1704, causes the processing system 1714 to perform the various functions described supra for any particular apparatus. The computer-readable medium/memory 1706 may also be used for storing data that is manipulated by the processor 1704 when executing software. The processing system 1714 further includes at least one of the components 1604, 1606, 1608, 1610, 1612, 1614, and 1616. The components 1604, 1606, 1608, 1610, 1612, 1614, and 1616 may be software components running in the processor 1704, resident/stored in the computer readable medium/memory 1706, one or more hardware components coupled to the processor 1704, or some combination thereof.

In certain configurations, the apparatus 1602/1602′ for wireless communication may include means for all means limitations described herein. The aforementioned means may be the processor(s) 202, the radio 230, the MMU 240, the WLAN controller 250, the Bluetooth controller 252, the WWAN controller 256, one or more of the aforementioned components of the apparatus 1602 and/or the processing system 1714 of the apparatus 1602′ configured to perform the functions recited by the aforementioned means.

In one configuration, the apparatus 1602/1602′ for wireless communication includes means for establishing a Bluetooth connection with a peripheral device based on one or more Bluetooth Specifications, means for transmitting one or more first Bluetooth-encoded data frames to the peripheral device over the Bluetooth connection, means for initiating a first handover operation for communications between the wireless device and the peripheral device responsive to a link metric of the Bluetooth connection being less than a first link metric threshold, and means for transmitting one or more second Bluetooth-encoded data frames to the peripheral device over the WLAN channel. In some instances, initiating the first handover operation may include selecting an access point (AP) of one or more candidate APs based on signal strengths of frames received from the one or more candidate APs, and switching the communications between the wireless device and the peripheral device from the Bluetooth connection to a wireless local area network (WLAN) channel associated with the selected AP.

The apparatus 1602/1602′ for wireless communication may also include means for transmitting one or more additional Bluetooth-encoded data frames to the peripheral device over the Bluetooth connection, without initiating the first handover operation, responsive to the link metric of the Bluetooth connection being greater than the first link metric threshold. In some implementations, the apparatus 1602/1602′ for wireless communication may also include means for initiating a second handover operation for the communications between the wireless device and the peripheral device responsive to a signal strength of a Bluetooth advertisement message received over the Bluetooth connection exceeding a signal strength threshold, means for switching the communications from the WLAN channel to the Bluetooth connection based on the Bluetooth link metric being greater than a second link metric threshold, and means for transmitting one or more third Bluetooth-encoded data frames to the peripheral device over the Bluetooth connection.

The aforementioned means may be one or more of the aforementioned components of the apparatus 1602 and/or the processing system 1714 of the apparatus 1602′ configured to perform the functions recited by the aforementioned means. As described supra, the processing system 1714 may include the processors 202, the memory 206, the flash memory 210, and/or the ROM 208 of FIG. 2.

Implementation examples are described in the following numbered clauses:
1. A method for wireless communication by a wireless device, including:
establishing a Bluetooth connection with a peripheral device based on one or more Bluetooth Specifications;
transmitting one or more first Bluetooth-encoded data frames to the peripheral device over the Bluetooth connection;
initiating a first handover operation for communications between the wireless device and the peripheral device responsive to a link metric of the Bluetooth connection being less than a first link metric threshold, the first handover operation including:
   selecting an access point (AP) of one or more candidate APs based on signal strengths of frames received from the one or more candidate APs; and
   switching the communications between the wireless device and the peripheral device from the Bluetooth connection to a wireless local area network (WLAN) channel associated with the selected AP; and
transmitting one or more second Bluetooth-encoded data frames to the peripheral device over the WLAN channel.
2. The method of clause 1, where the WLAN channel includes one or more wireless channels in a 2.4 GHz frequency band, a 5 GHz frequency band, or a 6 GHz frequency band.
3. The method of any one or more of clauses 1-2, where the WLAN channel includes at least one of a peer-to-peer (P2P) link, a tunneled direct-link setup (TDLS) link, a Wi-Fi Direct link, a link associated with a Group Owner (GO), or a link associated with a Neighborhood Area Network (NAN).
4. The method of any one or more of clauses 1-3, where the one or more second Bluetooth-encoded data frames are encapsulated within physical layer convergence protocol (PLCP) protocol data units (PPDUs) compliant with the IEEE 802.11 family of wireless communication standards for transmission to the peripheral device over the WLAN channel.
5. The method of any one or more of clauses 1-4, further including:
transmitting one or more additional Bluetooth-encoded data frames to the peripheral device over the Bluetooth connection, without initiating the first handover operation, responsive to the Bluetooth link metric being greater than the first link metric threshold.
6. The method of any one or more of clauses 1-5, where the link metric includes one or more of received signal strength indicator (RSSI) values of the first Bluetooth-encoded data frames, a quality of the Bluetooth connection, a data rate associated with the Bluetooth connection, a packet error rate (PER) associated with the Bluetooth connection, an average channel access time associated with the Bluetooth connection, or a presence of concurrent downlink (DL) and uplink (UL) transmissions associated with the peripheral device.
7. The method of any one or more of clauses 1-6, where initiating the first handover operation is further based on a distance between the peripheral device and the wireless device.
8. The method of clause 7, where initiating the first handover operation includes:
initiating the first handover operation based on the distance being greater than a value or the distance increasing by more than an amount; or
refraining from initiating the first handover operation based on the distance being less than the value or the distance not increasing by more than the amount.
9. The method of any one or more of clauses 1-8, where the link metric comprises a level of co-existence interference between the Bluetooth connection and respective WLAN channels associated with the one or more candidate APs.
10. The method of clause 9, where initiating the first handover operation includes:
initiating the first handover operation based on the level of co-existence interference being greater than an interference threshold; or
refraining from initiating the first handover operation based on the level of co-existence interference being less than the interference threshold.
11. The method of any one or more of clauses 1-10, where selecting the AP includes:
obtaining received signal strength indicator (RSSI) values of beacon frames received from one or more candidate access points (APs);
identifying the AP of the one or more candidate APs associated with the beacon frame having a highest RSSI value of the obtained RSSI values; and
associating with the identified AP over the WLAN channel.
12. The method of any one or more of clauses 1-11, further including:
initiating a second handover operation for the communications between the wireless device and the peripheral device responsive to a signal strength of a Bluetooth advertisement message received from the peripheral device exceeding a signal strength threshold;
switching the communications between the wireless device and the peripheral device from the WLAN channel to the Bluetooth connection based on the link metric of the Bluetooth connection being greater than a second link metric threshold; and
transmitting one or more third Bluetooth-encoded data frames to the peripheral device over the Bluetooth connection.
13. The method of clause 12, where the signal strength includes an average received signal strength indicator (RSSI) value of one or more Bluetooth advertisement messages received from the peripheral device, and the second link metric threshold is based at least in part on a weighted set of RSSI values associated with previously received Bluetooth messages.
14. The method of clause 12, where switching the communications from the WLAN channel to the Bluetooth connection is further based on one or more of a quality of the Bluetooth connection, a data rate associated with the Bluetooth connection, a packet error rate (PER) associated with the Bluetooth connection, an average channel access time associated with the Bluetooth connection, a presence of concurrent downlink (DL) and uplink (UL) transmissions associated with the peripheral device, or a level of cross-link interference associated with the concurrent DL and UL transmissions.
15. The method of any one or more of clauses 1-14, further including:
operating the wireless communication as a wireless station (STA) associated with the selected AP operating on the WLAN channel while also operating as a software-enabled access point (softAP) paired with the peripheral device over the Bluetooth connection.
16. The method of clause 15, where the peripheral device includes a first earbud and a second earbud, the softAP connected to only one of the first and second earbuds via the Bluetooth connection.
17. The method of clause 16, where the first and second earbuds are independently associated with the softAP.
18. A wireless device, including:
one or more wireless radios;
one or more processors coupled to the one or more wireless radios; and
a memory coupled to the one or more processors and storing processor-executable code that, when executed by the one or more processors in conjunction with the one or more wireless radios, is configured to:
   establish a Bluetooth connection with a peripheral device based on one or more Bluetooth Specifications;
   transmit one or more first Bluetooth-encoded data frames to the peripheral device over the Bluetooth connection;
   initiate a first handover operation for communications between the wireless device and the peripheral device responsive to a link metric of the Bluetooth connection being less than a first link metric threshold, the first handover operation including:
      select an access point (AP) of one or more candidate APs based on signal strengths of frames received from the one or more candidate APs; and
      switch the communications between the wireless device and the peripheral device from the Bluetooth connection to a wireless local area network (WLAN) channel associated with the selected AP; and
   transmit one or more second Bluetooth-encoded data frames to the peripheral device over the WLAN channel.
19. The wireless device of clause 18, where the WLAN channel includes one or more wireless channels in a 2.4 GHz frequency band, a 5 GHz frequency band, or a 6 GHz frequency band.
20. The wireless device of any one or more of clauses 18-19, where the WLAN channel includes at least one of a peer-to-peer (P2P) link, a tunneled direct-link setup (TDLS) link, a Wi-Fi Direct link, a link associated with a Group Owner (GO), or a link associated with a Neighborhood Area Network (NAN).
21. The wireless device of any one or more of clauses 18-20, where the one or more second Bluetooth-encoded data frames are encapsulated within physical layer convergence protocol (PLCP) protocol data units (PPDUs) compliant with the IEEE 802.11 family of wireless communication standards for transmission to the peripheral device over the WLAN channel.
22. The wireless device of any one or more of clauses 18-21, where execution of the processor-executable code is further configured to:
transmit one or more additional Bluetooth-encoded data frames to the peripheral device over the Bluetooth connection, without initiating the first handover operation, responsive to the Bluetooth link metric being greater than the first link metric threshold.
23. The wireless device of any one or more of clauses 18-22, where the link metric includes one or more of received signal strength indicator (RSSI) values of the first Bluetooth-encoded data frames, a quality of the Bluetooth connection, a data rate associated with the Bluetooth connection, a packet error rate (PER) associated with the Bluetooth connection, an average channel access time associated with the Bluetooth connection, or a presence of concurrent downlink (DL) and uplink (UL) transmissions associated with the peripheral device.
24. The wireless device of any one or more of clauses 18-23, where initiating the first handover operation is further based on a distance between the peripheral device and the wireless device.
25. The wireless device of clause 24, where execution of the processor-executable code for initiating the first handover operation is further configured to:
initiate the first handover operation based on the distance being greater than a value or the distance increasing by more than an amount; or
refrain from initiating the first handover operation based on the distance being less than the value or the distance not increasing by more than the amount.
26. The wireless device of any one or more of clauses 18-25, where the link metric comprises a level of co-existence interference between the Bluetooth connection and respective WLAN channels associated with the one or more candidate APs.
27. The wireless device of clause 26, where execution of the processor-executable code for initiating the first handover operation is further configured to:
initiate the first handover operation based on the level of co-existence interference being greater than an interference threshold; or
refrain from initiating the first handover operation based on the level of co-existence interference being less than the interference threshold.
28. The wireless device of any one or more of clauses 18-27, where execution of the processor-executable code for selecting the AP is further configured to:
obtain received signal strength indicator (RSSI) values of beacon frames received from one or more candidate access points (APs);
identify the AP of the one or more candidate APs associated with the beacon frame having a highest RSSI value of the obtained RSSI values; and
associate with the identified AP over the WLAN channel.
29. The wireless device of any one or more of clauses 18-28, where execution of the processor-executable code is further configured to:
initiate a second handover operation for the communications between the wireless device and the peripheral device responsive to a signal strength of a Bluetooth advertisement message received from the peripheral device exceeding a signal strength threshold;
switch the communications between the wireless device and the peripheral device from the WLAN channel to the Bluetooth connection based on the link metric of the Bluetooth connection being greater than a second link metric threshold; and
transmit one or more third Bluetooth-encoded data frames to the peripheral device over the Bluetooth connection.
30. The wireless device of clause 29, where the signal strength includes an average received signal strength indicator (RSSI) value of one or more Bluetooth advertisement messages received from the peripheral device, and the second link metric threshold is based at least in part on a weighted set of RSSI values associated with previously received Bluetooth messages.
31. The wireless device of clause 29, where switching the communications from the WLAN channel to the Bluetooth connection is further based on one or more of a quality of the Bluetooth connection, a data rate associated with the Bluetooth connection, a packet error rate (PER) associated with the Bluetooth connection, an average channel access time associated with the Bluetooth connection, a presence of concurrent downlink (DL) and uplink (UL) transmissions associated with the peripheral device, or a level of cross-link interference associated with the concurrent DL and UL transmissions.
32. The wireless device of any one or more of clauses 18-31, where execution of the processor-executable code is further configured to:
operate the wireless communication as a wireless station (STA) associated with the selected AP operating on the WLAN channel while also operating as a software-enabled access point (softAP) paired with the peripheral device over the Bluetooth connection.
33. The wireless device of any one or more of clauses 18-32, where the peripheral device includes a first earbud and a second earbud, the softAP connected to only one of the first and second earbuds via the Bluetooth connection.
34. The wireless device of any one or more of clauses 18-33, where the first and second earbuds are independently associated with the softAP.
35. A method for wireless communication by a Bluetooth-enabled peripheral device paired with a software-enabled access point (softAP) via a Bluetooth connection, including:
associating with a first access point (AP) operating on a wireless local area network (WLAN) channel;
exchanging one or more first Bluetooth-encoded data frames with the first AP over the WLAN channel;
switching communications from the first AP to a second AP during a handover operation responsive to a link metric of the WLAN channel indicating one or both of a decrease in received signal strength indicator (RSSI) values of the first Bluetooth-encoded data frames or an increase in a packet error rate (PER) of the first Bluetooth-encoded data frames; and
exchanging one or more second Bluetooth-encoded data frames with the second AP over the WLAN channel after the handover operation.
36. The method of clause 35, where the first AP and the second AP belong to the same basic service set (BSS) or extended BSS (ESS).
37. The method of any one or more of clauses 35-36, where the WLAN channel includes one or more wireless channels in a 2.4 GHz frequency band, a 5 GHz frequency band, or a 6 GHz frequency band.
38. The method of any one or more of clauses 35-37, where the WLAN channel includes at least one of a peer-to-peer (P2P) link, a tunneled direct-link setup (TDLS) link, a Wi-Fi Direct link, a link associated with a Group Owner (GO), or a link associated with a Neighborhood Area Network (NAN).
39. The method of any one or more of clauses 35-38, where the first and second Bluetooth-encoded data frames are encapsulated within physical layer convergence protocol (PLCP) protocol data units (PPDUs) compliant with the IEEE 802.11 family of wireless communication standards for transmission over the WLAN channel.
40. The method of any one or more of clauses 35-39, further including:
exchanging one or more additional Bluetooth-encoded data frames with the first AP over the WLAN channel responsive to the link metric of the WLAN channel indicating one or both of an absence of the decrease in the RSSI values of the first Bluetooth-encoded data frames or an absence of the increase in the PER of the first Bluetooth-encoded data frames.
41. The method of any one or more of clauses 35-40, where switching the communications during the handover operation is further based on respective distances between the peripheral device and each of the first AP and the second AP.
42. The method of any one or more of clauses 35-41, where switching the communications during the handover operation is further based, at least in part, on a location of the peripheral device being outside a wireless coverage area of the first AP, on the location of the peripheral device being outside a wireless coverage area of the softAP, on the location of the peripheral device being within a wireless coverage area of the second AP, or any combination thereof.
43. The method of any one or more of clauses 35-42, where the peripheral device includes a first earbud and a second earbud, the first and second earbuds paired with the softAP via at least one of an Asynchronous Connection-Less (ACL) link, a Logical Link Control and Adaptation Protocol (L2CAP) link, an Advanced Audio Distribution Profile (A2DP) link, a Synchronous Connection-Oriented (SCO) link, or an Isochronous (ISO) link.
44. The method of clause 43, where the first and second earbuds are independently associated with the softAP.
45. A Bluetooth-enabled peripheral device, including:
one or more processors; and
a memory coupled to the one or more processors and storing processor-executable code that, when executed by the one or more processors, is configured to:
   associate with a first access point (AP) operating on a wireless local area network (WLAN) channel;
   exchange one or more first Bluetooth-encoded data frames with the first AP over the WLAN channel;
   switch communications from the first AP to a second AP during a handover operation responsive to a link metric of the WLAN channel indicating one or both of a decrease in received signal strength indicator (RSSI) values of the first Bluetooth-encoded data frames or an increase in a packet error rate (PER) of the first Bluetooth-encoded data frames; and
   exchange one or more second Bluetooth-encoded data frames with the second AP over the WLAN channel after the handover operation.
46. The Bluetooth-enabled peripheral device of clause 45, where the first AP and the second AP belong to the same basic service set (BSS) or extended BSS (ESS).
47. The Bluetooth-enabled peripheral device of any one or more of clauses 45-46, where the WLAN channel includes one or more wireless channels in a 2.4 GHz frequency band, a 5 GHz frequency band, or a 6 GHz frequency band.
48. The Bluetooth-enabled peripheral device of any one or more of clauses 45-47, where the WLAN channel includes at least one of a peer-to-peer (P2P) link, a tunneled direct-link setup (TDLS) link, a Wi-Fi Direct link, a link associated with a Group Owner (GO), or a link associated with a Neighborhood Area Network (NAN).
49. The Bluetooth-enabled peripheral device of any one or more of clauses 45-48, where the first and second Bluetooth-encoded data frames are encapsulated within physical layer convergence protocol (PLCP) protocol data units (PPDUs) compliant with the IEEE 802.11 family of wireless communication standards for transmission over the WLAN channel.
50. The Bluetooth-enabled peripheral device of any one or more of clauses 45-49, where execution of the processor-executable code is further configured to:
exchange one or more additional Bluetooth-encoded data frames with the first AP over the WLAN channel responsive to the link metric of the WLAN channel indicating one or both of an absence of the decrease in the RSSI values of the first Bluetooth-encoded data frames or an absence of the increase in the PER of the first Bluetooth-encoded data frames.
51. The Bluetooth-enabled peripheral device of any one or more of clauses 45-50, where switching the communications during the handover operation is further based on respective distances between the peripheral device and each of the first AP and the second AP.
52. The Bluetooth-enabled peripheral device of any one or more of clauses 45-51, where switching the communications during the handover operation is further based, at least in part, on a location of the peripheral device being outside a wireless coverage area of the first AP, on the location of the peripheral device being outside a wireless coverage area of the softAP, on the location of the peripheral device being within a wireless coverage area of the second AP, or any combination thereof.
53. The Bluetooth-enabled peripheral device of any one or more of clauses 45-52, where the peripheral device includes a first earbud and a second earbud, the first and second earbuds paired with the softAP via at least one of an Asynchronous Connection-Less (ACL) link, a Logical Link Control and Adaptation Protocol (L2CAP) link, an Advanced Audio Distribution Profile (A2DP) link, a Synchronous Connection-Oriented (SCO) link, or an Isochronous (ISO) link.
54. The Bluetooth-enabled peripheral device of clause 53, where the first and second earbuds are independently associated with the softAP.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations, and algorithm processes described in connection with the implementations disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described herein as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products.

1. A method for wireless communication by a wireless device, comprising:
establishing a Bluetooth connection with a peripheral device based on one or more Bluetooth Specifications;
transmitting one or more first Bluetooth-encoded data frames to the peripheral device over the Bluetooth connection;
initiating a first handover operation for communications between the wireless device and the peripheral device responsive to a link metric of the Bluetooth connection being less than a first link metric threshold, the first handover operation including:
selecting an access point (AP) of one or more candidate APs based on signal strengths of frames received from the one or more candidate APs; and
switching the communications between the wireless device and the peripheral device from the Bluetooth connection to a wireless local area network (WLAN) channel associated with the selected AP; and
transmitting one or more second Bluetooth-encoded data frames to the peripheral device over the WLAN channel.

2. (canceled)

3. (canceled)

4. (canceled)

5. The method of claim 1, further comprising:
transmitting one or more additional Bluetooth-encoded data frames to the peripheral device over the Bluetooth connection, without initiating the first handover operation, responsive to the link metric of the Bluetooth connection being greater than the first link metric threshold.

6. The method of claim 1, wherein the link metric includes one or more of received signal strength indicator (RSSI) values of the one or more first Bluetooth-encoded data frames, a quality of the Bluetooth connection, a data rate associated with the Bluetooth connection, a packet error rate (PER) associated with the Bluetooth connection, an average quantity of packet retransmissions on the Bluetooth connection, or a presence of concurrent downlink (DL) and uplink (UL) transmissions associated with the peripheral device.

7. (canceled)

8. The method of claim 1, wherein initiating the first handover operation is further based on a distance between the peripheral device and the wireless device, and wherein initiating the first handover operation comprises:
initiating the first handover operation based on the distance being greater than a value or the distance increasing by more than an amount; or
refraining from initiating the first handover operation based on the distance being less than the value or the distance not increasing by more than the amount.

9. (canceled)

10. The method of claim 1, wherein the link metric comprises a level of co-existence interference between the Bluetooth connection and respective WLAN channels associated with the one or more candidate APs, and wherein initiating the first handover operation comprises:
initiating the first handover operation based on the level of co-existence interference being greater than an interference threshold; or
refraining from initiating the first handover operation based on the level of co-existence interference being less than the interference threshold.

11. The method of claim 1, wherein selecting the AP includes:
obtaining received signal strength indicator (RSSI) values of one or more beacon frames received from one or more candidate access points (APs);
identifying the AP of the one or more candidate APs associated with the one or more beacon frames having a highest RSSI value of the obtained RSSI values; and
associating with the identified AP over the WLAN channel.

12. The method of claim 1, further comprising:
initiating a second handover operation for the communications between the wireless device and the peripheral device responsive to a signal strength of a Bluetooth advertisement message received from the peripheral device exceeding a signal strength threshold, wherein the signal strength comprises an average received signal strength indicator (RSSI) value of one or more Bluetooth advertisement messages received from the peripheral device, and the second link metric threshold is based at least in part on a weighted set of RSSI values associated with previously received Bluetooth messages;
switching the communications between the wireless device and the peripheral device from the WLAN channel to the Bluetooth connection based on the link metric of the Bluetooth connection being greater than a second link metric threshold and based on one or more of a quality of the Bluetooth connection, a data rate associated with the Bluetooth connection, a packet error rate (PER) associated with the Bluetooth connection, an average quantity of packet retransmissions on the Bluetooth connection, a presence of concurrent downlink (DL) and uplink (UL) transmissions associated with the peripheral device, or a level of cross-link interference associated with the concurrent DL and UL transmissions; and
transmitting one or more third Bluetooth-encoded data frames to the peripheral device over the Bluetooth connection.

13. (canceled)

14. (canceled)

15. The method of claim 1, further comprising:
operating the wireless communication as a wireless station (STA) associated with the selected AP operating on the WLAN channel while also operating as a software-enabled access point (softAP) paired with the peripheral device over the Bluetooth connection.

16. (canceled)

17. (canceled)

18. A wireless device, comprising:
one or more processors; and
a memory coupled to the one or more processors and storing processor-executable code that, when executed by the one or more processors, is configured to:
establish a Bluetooth connection with a peripheral device based on one or more Bluetooth Specifications;
transmit one or more first Bluetooth-encoded data frames to the peripheral device over the Bluetooth connection;
initiate a first handover operation for communications between the wireless device and the peripheral device responsive to a link metric of the Bluetooth connection being less than a first link metric threshold, the first handover operation including:
select an access point (AP) of one or more candidate APs based on signal strengths of frames received from the one or more candidate APs; and
switch the communications between the wireless device and the peripheral device from the Bluetooth connection to a wireless local area network (WLAN) channel associated with the selected AP; and
transmit one or more second Bluetooth-encoded data frames to the peripheral device over the WLAN channel.

19. (canceled)

20. (canceled)

21. (canceled)

22. The wireless device of claim 18, wherein execution of the processor-executable code is further configured to:
transmit one or more additional Bluetooth-encoded data frames to the peripheral device over the Bluetooth connection, without initiating the first handover operation, responsive to the link metric of the Bluetooth connection being greater than the first link metric threshold.

23. The wireless device of claim 18, wherein the link metric includes one or more of received signal strength indicator (RSSI) values of the one or more first Bluetooth-encoded data frames, a quality of the Bluetooth connection, a data rate associated with the Bluetooth connection, a packet error rate (PER) associated with the Bluetooth connection, an average quantity of packet retransmissions on the Bluetooth connection, or a presence of concurrent downlink (DL) and uplink (UL) transmissions associated with the peripheral device.

24. (canceled)

25. The wireless device of claim 18, wherein initiating the first handover operation is further based on a distance between the peripheral device and the wireless device, and wherein execution of the processor-executable code for initiating the first handover operation is further configured to:
initiate the first handover operation based on the distance being greater than a value or the distance increasing by more than an amount; or
refrain from initiating the first handover operation based on the distance being less than the value or the distance not increasing by more than the amount.

26. (canceled)

27. The wireless device of claim 18, wherein the link metric comprises a level of co-existence interference between the Bluetooth connection and respective WLAN channels associated with the one or more candidate APs, and wherein execution of the processor-executable code for initiating the first handover operation is further configured to:
initiate the first handover operation based on the level of co-existence interference being greater than an interference threshold; or
refrain from initiating the first handover operation based on the level of co-existence interference being less than the interference threshold.

28. The wireless device of claim 18, wherein execution of the processor-executable code for selecting the AP is further configured to:
obtain received signal strength indicator (RSSI) values of one or more beacon frames received from one or more candidate access points (APs);
identify the AP of the one or more candidate APs associated with the one or more beacon frames having a highest RSSI value of the obtained RSSI values; and
associate with the identified AP over the WLAN channel.

29. The wireless device of claim 18, wherein execution of the processor-executable code is further configured to:
initiate a second handover operation for the communications between the wireless device and the peripheral device responsive to a signal strength of a Bluetooth advertisement message received from the peripheral device exceeding a signal strength threshold, wherein the signal strength comprises an average received signal strength indicator (RSSI) value of one or more Bluetooth advertisement messages received from the peripheral device, and the second link metric threshold is based at least in part on a weighted set of RSSI values associated with previously received Bluetooth message;
switch the communications between the wireless device and the peripheral device from the WLAN channel to the Bluetooth connection based on the link metric of the Bluetooth connection being greater than a second link metric threshold and based on one or more of a quality of the Bluetooth connection, a data rate associated with the Bluetooth connection, a packet error rate (PER) associated with the Bluetooth connection, an average quantity of packet retransmissions on the Bluetooth connection, a presence of concurrent downlink (DL) and uplink (UL) transmissions associated with the peripheral device, or a level of cross-link interference associated with the concurrent DL and UL transmissions; and
transmit one or more third Bluetooth-encoded data frames to the peripheral device over the Bluetooth connection.

30. (canceled)

31. (canceled)

32. The wireless device of claim 18, wherein execution of the processor-executable code is further configured to:
operate the wireless communication as a wireless station (STA) associated with the selected AP operating on the WLAN channel while also operating as a software-enabled access point (softAP) paired with the peripheral device over the Bluetooth connection.

33. (canceled)

34. (canceled)

35. A method for wireless communication by a Bluetooth-enabled peripheral device paired with a software-enabled access point (softAP) via a Bluetooth connection, comprising:
associating with a first access point (AP) operating on a wireless local area network (WLAN) channel;
exchanging one or more first Bluetooth-encoded data frames with the first AP over the WLAN channel;
switching communications from the first AP to a second AP during a handover operation responsive to a link metric of the WLAN channel indicating one or both of a decrease in received signal strength indicator (RSSI) values of the first Bluetooth-encoded data frames or an increase in a packet error rate (PER) of the first Bluetooth-encoded data frames; and
exchanging one or more second Bluetooth-encoded data frames with the second AP over the WLAN channel after the handover operation.

36. The method of claim 35, wherein the first AP and the second AP belong to the same basic service set (BSS) or extended BSS (ESS).

37. (canceled)

38. (canceled)

39. The method of claim 35, wherein the one or more first Bluetooth-encoded data frames and the one or more second Bluetooth-encoded data frames are encapsulated within physical layer convergence protocol (PLCP) protocol data units (PPDUs) compliant with the IEEE 802.11 family of wireless communication standards for transmission over the WLAN channel.

40. The method of claim 35, further comprising:
exchanging one or more additional Bluetooth-encoded data frames with the first AP over the WLAN channel responsive to the link metric of the WLAN channel indicating one or both of an absence of the decrease in the RSSI values of the one or more first Bluetooth-encoded data frames or an absence of the increase in the PER of the one or more first Bluetooth-encoded data frames.

41. The method of claim 35, wherein switching the communications during the handover operation is further based on respective distances between the Bluetooth-enabled peripheral device and each of the first AP and the second AP.

42. The method of claim 35, wherein switching the communications during the handover operation is further based, at least in part, on a location of the Bluetooth-enabled peripheral device being outside a wireless coverage area of the first AP, on the location of the Bluetooth-enabled peripheral device being outside a wireless coverage area of the softAP, on the location of the Bluetooth-enabled peripheral device being within a wireless coverage area of the second AP, or any combination thereof.

43. The method of claim 35, wherein the Bluetooth-enabled peripheral device includes a first earbud and a second earbud, the first and second earbuds paired with the softAP via at least one of an Asynchronous Connection-Less (ACL) link, a Logical Link Control and Adaptation Protocol (L2CAP) link, an Advanced Audio Distribution Profile (A2DP) link, a Synchronous Connection-Oriented (SCO) link, or an Isochronous (ISO) link.

44. (canceled)

45. A Bluetooth-enabled peripheral device paired with a software-enabled access point (softAP) via a Bluetooth connection, comprising:
one or more processors; and
a memory coupled to the one or more processors and storing processor-executable code that, when executed by the one or more processors, is configured to:
associate with a first access point (AP) operating on a wireless local area network (WLAN) channel;
exchange one or more first Bluetooth-encoded data frames with the first AP over the WLAN channel;
switch communications from the first AP to a second AP during a handover operation responsive to a link metric of the WLAN channel indicating one or both of a decrease in received signal strength indicator (RSSI) values of the first Bluetooth-encoded data frames or an increase in a packet error rate (PER) of the first Bluetooth-encoded data frames; and
exchange one or more second Bluetooth-encoded data frames with the second AP over the WLAN channel after the handover operation.

46. The Bluetooth-enabled peripheral device of claim 45, wherein the first AP and the second AP belong to the same basic service set (BSS) or extended BSS (ESS).

47. (canceled)

48. (canceled)

49. The Bluetooth-enabled peripheral device of claim 45, wherein one or more first Bluetooth-encoded data frames and the one or more second Bluetooth-encoded data frames are encapsulated within physical layer convergence protocol (PLCP) protocol data units (PPDUs) compliant with the IEEE 802.11 family of wireless communication standards for transmission over the WLAN channel.

50. The Bluetooth-enabled peripheral device of claim 45, wherein execution of the processor-executable code is further configured to:
exchange one or more additional Bluetooth-encoded data frames with the first AP over the WLAN channel responsive to the link metric of the WLAN channel indicating one or both of an absence of the decrease in the RSSI values of the one or more first Bluetooth-encoded data frames or an absence of the increase in the PER of the one or more first Bluetooth-encoded data frames.

51. The Bluetooth-enabled peripheral device of claim 45, wherein switching the communications during the handover operation is further based on respective distances between the Bluetooth-enabled peripheral device and each of the first AP and the second AP.

52. The Bluetooth-enabled peripheral device of claim 45, wherein switching the communications during the handover operation is further based, at least in part, on a location of the Bluetooth-enabled peripheral device being outside a wireless coverage area of the first AP, on the location of the Bluetooth-enabled peripheral device being outside a wireless coverage area of the softAP, on the location of the Bluetooth-enabled peripheral device being within a wireless coverage area of the second AP, or any combination thereof.

53. The Bluetooth-enabled peripheral device of claim 45, wherein the Bluetooth-enabled peripheral device includes a first earbud and a second earbud, the first and second earbuds paired with the softAP via at least one of an Asynchronous Connection-Less (ACL) link, a Logical Link Control and Adaptation Protocol (L2CAP) link, an Advanced Audio Distribution Profile (A2DP) link, a Synchronous Connection-Oriented (SCO) link, or an Isochronous (ISO) link.

54. (canceled)
